(19) United States
(12) Patent Application Publication
(10) Pub. No.: US 2010/0295231 A1
(43) Pub. Date: Nov. 25, 2010

(54) PAPER SHEET HANDLING DEVICE

(75) Inventor: Kazuya Igata, Gunma (JP)

Correspondence Address: CHERNOFF, VILHAUER, MCCLUNG & STENZEL, LLP, 601 SW Second Avenue, Suite 1600, Portland, OR, 97204, US

(73) Assignee: MAX CO., LTD., Tokyo (JP)

(21) Appl. No.: 12/445,920

(22) PCT Filed: Oct. 17, 2007
(86) PCT No.: PCT/JP2007/070288

§ 371 Date: Apr. 16, 2009

(30) Foreign Application Priority Data
Oct. 17, 2006 (JP) 2006-282739

(51) Int. Cl. B65H 39/10; B41F 13/66; B42C 1/00

(52) U.S. Cl. 270/58.12

(57) ABSTRACT

A paper-sheet handling device is provided with a paper-sheet-holding unit 32 that causes the plurality of paper-sheets 3′ to butt against a reference position and stacks these paper-sheets 3′ to hold them temporarily and alignment pins 85a, 85b which align pinched holes 3a in the plurality of paper-sheets 3′ temporarily held by this paper-sheet-holding unit 32, as shown in FIG. 9. In this device, it is supposed that a distance from the reference position up to a predetermined position of the alignment pins 85a, 85b is S1 and a distance from front edges of the paper-sheets 3′ up to a predetermined position of the punched holes 3a is S2, the alignment pins 85a, 85b are disposed with respect to the reference position in such a manner as to satisfy a relationship of S1>S2. According to such a configuration, it is possible to have any room between the reference position and the alignment pins 85a, 85b when aligning the bundle of paper-sheets in which the punched holes are aligned so that a situation where the bundle of paper-sheets gets caught between the reference position and the alignment pins 85a, 85b can be avoided.

### TECHNICAL FIELD

This invention relates to a paper-sheet handling device that is preferably applied to an apparatus for performing a punching processing, a binding process or the like on recording paper-sheets released from a copy machine, a print machine or the like for black-and-white use and for color use. More particularly, it relates to the one in which a distance S1 from a reference position up to a predetermined position of alignment bar-shaped bodies and a distance S2 from the front edge of the paper-sheet up to a predetermined position of punched holes are set so as to satisfy a relationship of S1>S2 when positions of hole portions perforated at predetermined positions are aligned, respectively, at the predetermined position and a plurality of paper-sheets is bound into a bundle of paper-sheets, so that the alignment bar-shaped bodies are disposed with respect to the reference position, thereby enabling the insertion resistance to be reduced when inserting these bar-shaped bodies into the perforated hole portions in the paper-sheets at a moment of aligning the bundle of paper-sheets and allowing the hole portions in the bundle of paper-sheets to be aligned smoothly and instantaneously even if any variation arises in the positions of perforated hole portions.

### BACKGROUND ART

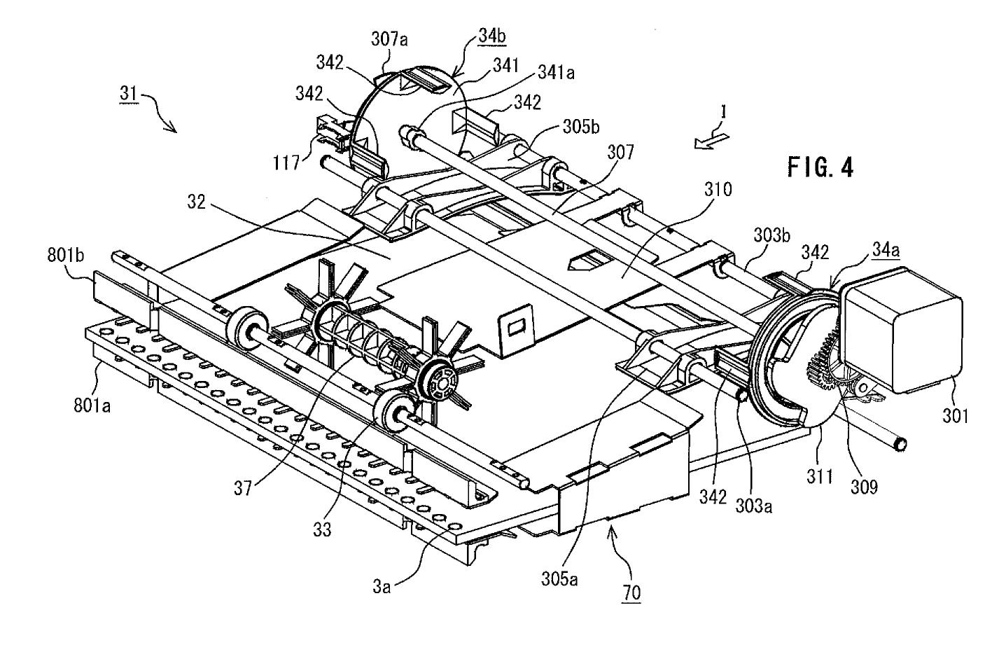

In recent years, a case in which a copy machine, a print machine or the like for black-and-white use and for color use is used by combining a paper-sheet handling device that carries out the perforation and binding processing has been increased. According to this kind of paper-sheet handling device, as disclosed in Japanese Patent Application Publication No. 2003-320780 (see page 2, FIG. 4), recording paper-sheets after the picture formation are received and are perforated on the downstream side of the paper-sheets thereof by utilizing the punching function. A plurality of paper-sheets after the perforation is aligned. A binding component is inserted automatically into perforated punched holes of the plurality of paper-sheets after the alignment.

By the way, for a case of aligning the plurality of paper-sheets after a perforation, a paper-sheet holding unit that temporarily holds these paper-sheets has been provided. An alignment-pins-driving mechanism has been provided in the paper-sheet holding unit and the plurality of paper-sheets entering thereinto from a paper-sheet-conveying path is stacked with aligning them. The stacked paper-sheets are aligned (pre-alignment process is performed) so that an end surface and a forward end of each of the paper-sheets meet the reference position. In this processing, the paper-sheets of one brochure are stacked and alignment pins are inserted into predetermined two punched holes of the bundle of paper-sheets so that they are realigned with reference to the position of the punched holes. It is configured that the bundle of realigned paper-sheets moves to a binding step with them being clamped by means of a clamp-movement mechanism. According to such a conventional paper-sheet handling device, however, there are following problems.

(i) If the alignment-pins-driving mechanism is installed into the paper-sheet holding unit the disclosed in Japanese Patent Application Publication No. 2003-320780 (see page 2, FIG. 4) so as to perform the pre-alignment process at the moment of aligning the bundle of paper-sheets and if any variation arises in distances from the punched holes of the paper-sheets up to a shutter or if any variation arises in distances from the punched holes up to forward ends of the paper-sheets, the bundle of paper-sheets (brochure) gets caught between the alignment pins and the shutter, thereby causing a risk of any poor pin insertion to occur.

(ii) If a guide member for truing up the widths of the paper-sheets is installed into the paper-sheet holding unit the disclosed in Japanese Patent Application Publication No. 2003-320780 (see page 2, FIG. 4) so as to perform the pre-alignment process and if any variation arises in distances from the end surfaces of the paper-sheets up to the punched holes, the bundle of paper-sheets (brochure) gets caught between the guide member for flushing the widths and the alignment pins, thereby causing a risk of any poor pin insertion to occur, similar to the item (i).

(iii) When performing such a pre-alignment process, a method of inserting the alignment pins from a side of the clamp member while movable clamp member constituting the movable clamp mechanism is opened is conceivable. In this method, it is configured that the alignment pins are pushed down from an upper surface of each of the paper-sheets to a lower surface thereof to insert into the pinched holes. In this method, the alignment pins (hereinafter, referred to as “bar-shaped body for alignment) push the paper-sheets down so that any frictional resistance is increased in the paper-sheets. Therefore, a pin-inserting resistance is increased, thereby causing a risk of any poor pin insertion to occur.

### DISCLOSURE OF INVENTION

A first paper-sheet handling device according to the present invention is a paper-sheet handling device that aligns positions of hole portions perforated at predetermined positions, respectively, and that binds a plurality of paper-sheets into a bundle of paper-sheets. The device is provided with a paper-sheet-holding unit that causes the plurality of the paper-sheets to butt against a reference position and stacks these paper-sheets to hold them temporarily and bar-shaped bodies for alignment, which align the hole portions in the plurality of paper-sheets temporarily held by the paper-sheet-holding unit. In the paper-sheet handling device, supposing that a distance from the reference position up to a predetermined position of the bar-shaped bodies is S1 and a distance from front edges of the paper-sheets up to a predetermined position of the hole portions is S2, the bar-shaped bodies are disposed with respect to the reference position in such a manner as to satisfy a relationship of S1>S2.

In the first paper-sheet handling device according to the present invention, an inventor finds out that the smallest deviation of the hole portions of the paper-sheets from the bar-shaped bodies for the alignment when performing pin-insertion processing at a position in which the pre-alignment process is performed so that the inserting resistance is decreased. Here, the pre-alignment process is referred to as “the forward ends of paper-sheets are butt against a reference position of the forward ends and are aligned as well as the end surfaces of the paper-sheets are pushed against a reference position of the end surfaces and are aligned”. Namely, if relative to the plurality of paper-sheets having of hole portions perforated at predetermined positions, respectively, they are bound into a bundle of paper-sheets with the positions of the hole portions being aligned, the paper-sheet holding unit causes the plurality of the paper-sheets to butt against a reference position and stacks these paper-sheets to hold them temporarily. On the assumption of this, the bar-shaped bodies for the alignment disposed with respect to the reference position in such a manner as to satisfy a relationship of S1>S2 align the hole portions of the plurality of paper-sheets held temporarily by the paper-sheet holding unit. Accordingly, it is possible to have any room between the reference position and the bar-shaped bodies for the alignment when aligning the bundle of paper-sheets so that a situation where the bundle of paper-sheets gets caught between the reference position and the bar-shaped bodies for the alignment can be avoided. This enables the insertion resistance to be reduced when inserting these bar-shaped bodies into the hole portions in the paper-sheets and allows the hole portions in the bundle of stacked paper-sheets to be aligned smoothly and instantaneously even if any variation arises in the positions of perforated hole portions.

A second paper-sheet handling device according to the present invention is a paper-sheet handling device that aligns positions of hole portions perforated at predetermined positions, respectively, and that binds a plurality of paper-sheets into a bundle of paper-sheets. The device is provided with a paper-sheet fixing and carriage mechanism that has a fixing clamp member and a movable clamp member and carries the bundle of paper-sheets with the bundle of the paper-sheets being fixed, and a bar-shaped-bodies-driving mechanism that reciprocates bar-shaped bodies between the fixing clam member and the movable clamp member of the paper-sheet fixing and carriage mechanism. At the time of aligning the bundle of the paper-sheets, it is configured that the bar-shaped bodies are projected from a side of the fixing clamp member to a side of the movable clamp member.

In the second paper-sheet handling device according to the present invention, a case is illustrated such that the positions of hole portions perforated at predetermined positions, respectively, are aligned and the plurality of paper-sheets is bound into a bundle of paper-sheets. At the time of aligning the bundle of the paper-sheets, bar-shaped-bodies-driving mechanism projects the bar-shaped bodies from a side of the fixing clamp member to a side of the movable clamp member of the paper-sheet fixing and carriage mechanism so that it reciprocates the bar-shaped bodies between the fixing clam member and the movable clamp member. Accordingly, it is possible to perform an insertion through the hole portions of the paper-sheets from the side of the fixing clamp member to the side of the movable clamp member. It is also possible to insert the pins therethrough without reducing a frictional resistance between paper-sheets because the paper-sheets are not pushed against from above. This enables the bundle of the paper-sheets in which the hole portions are aligned to be carried to next step with them being fixed by the fixing clam member and the movable clamp member.

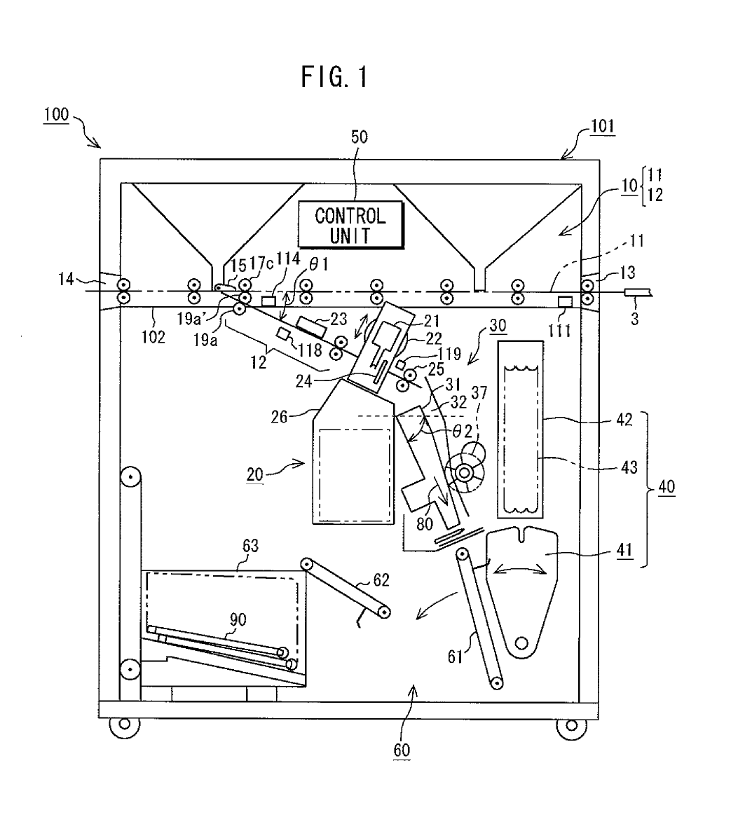

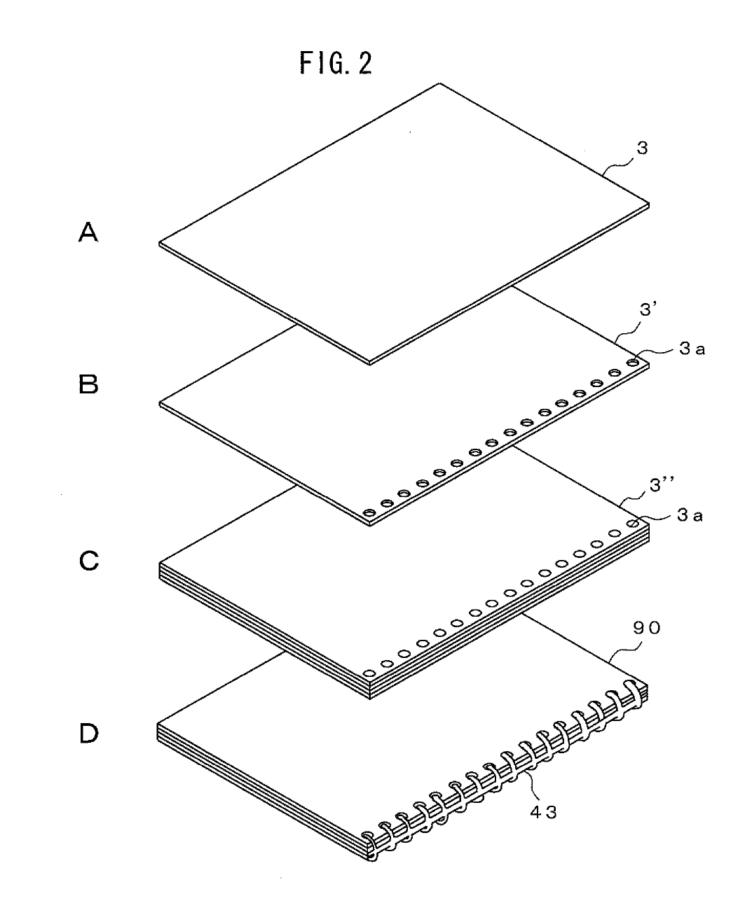

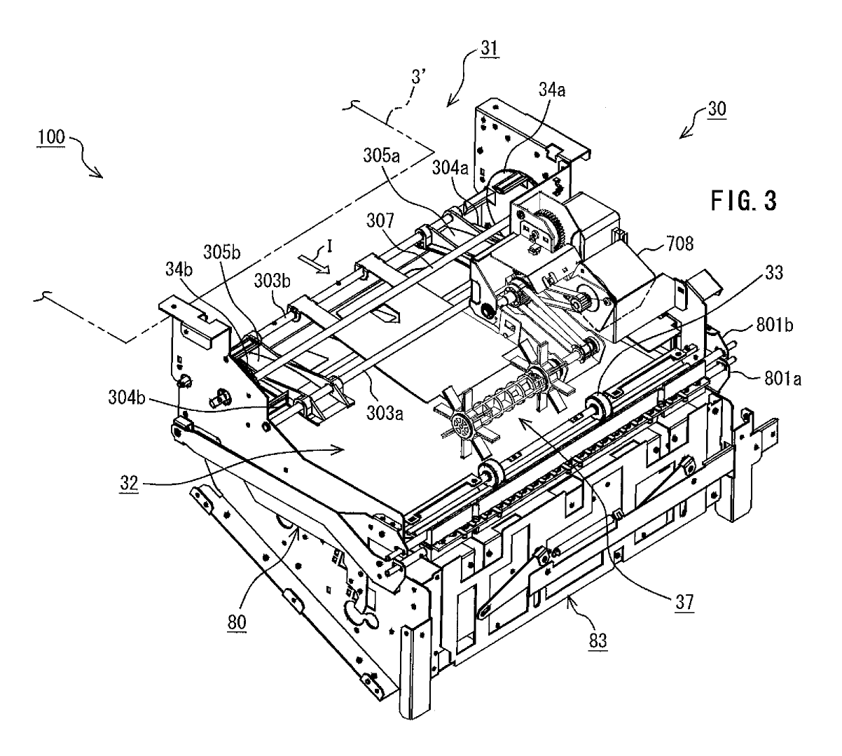

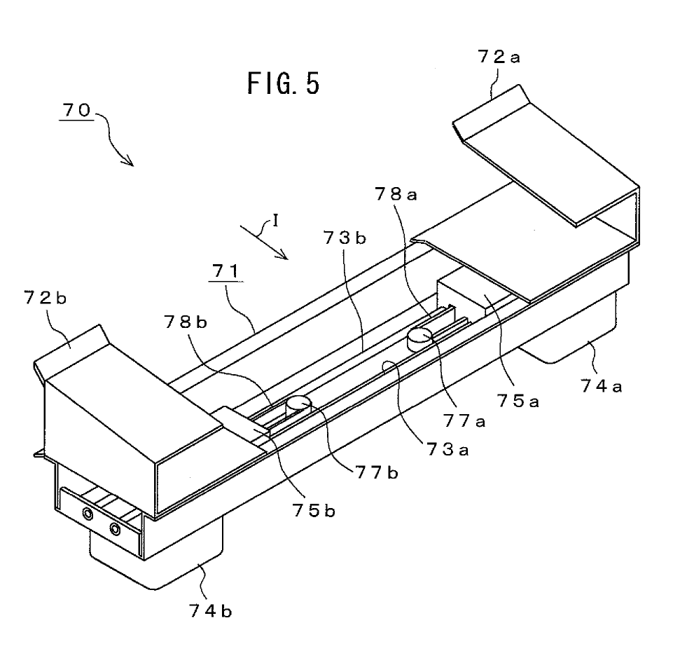

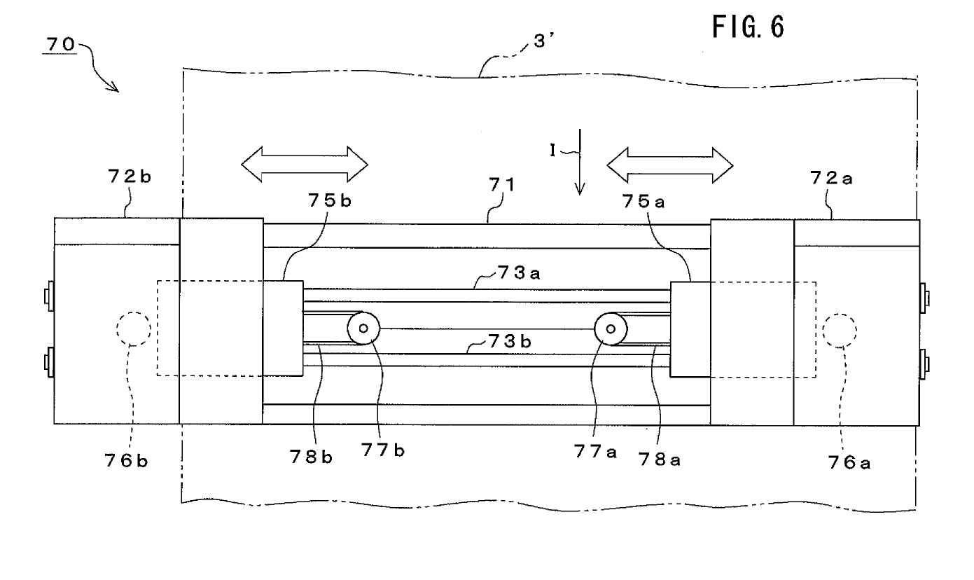

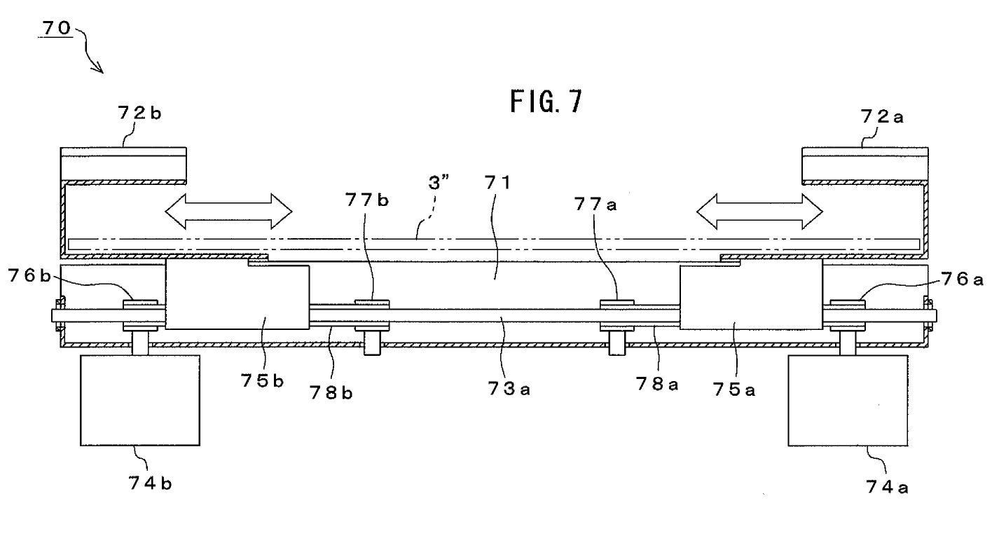

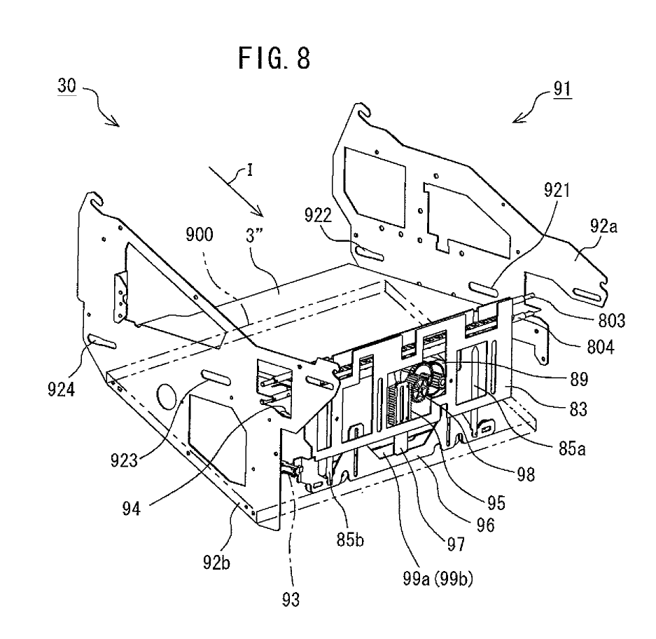

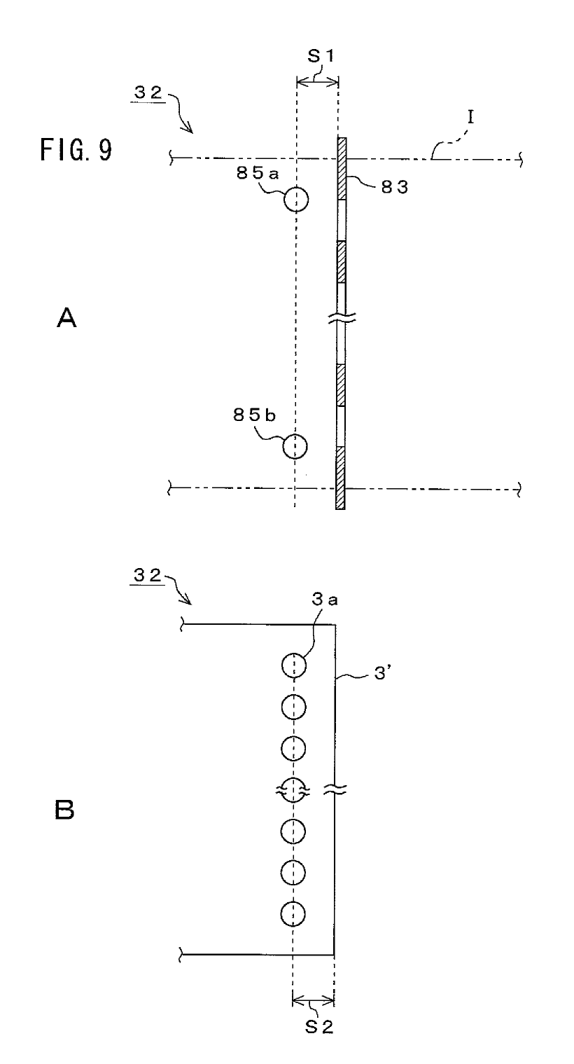

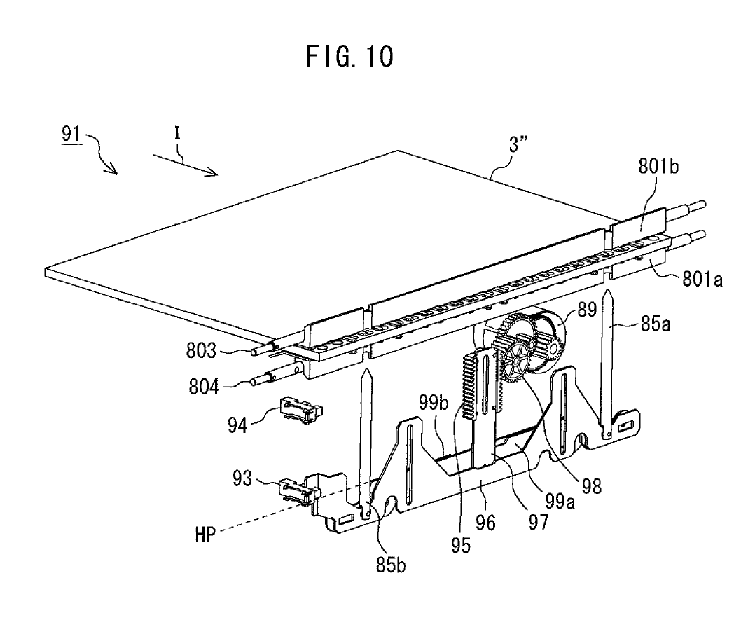

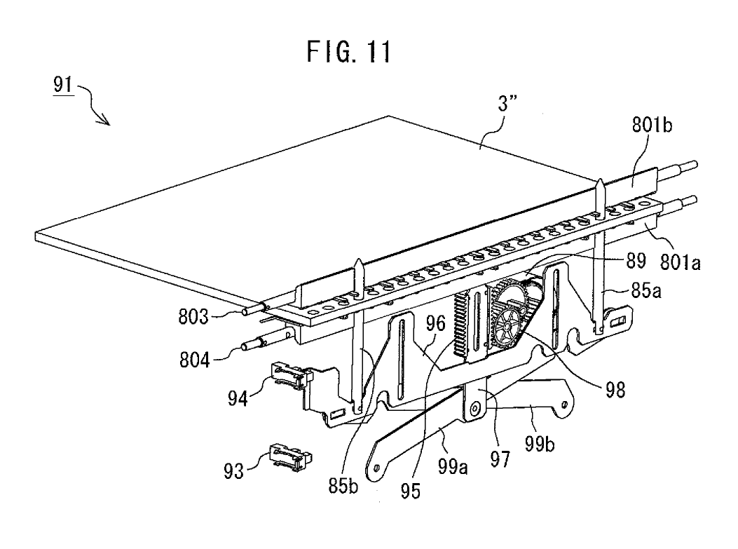

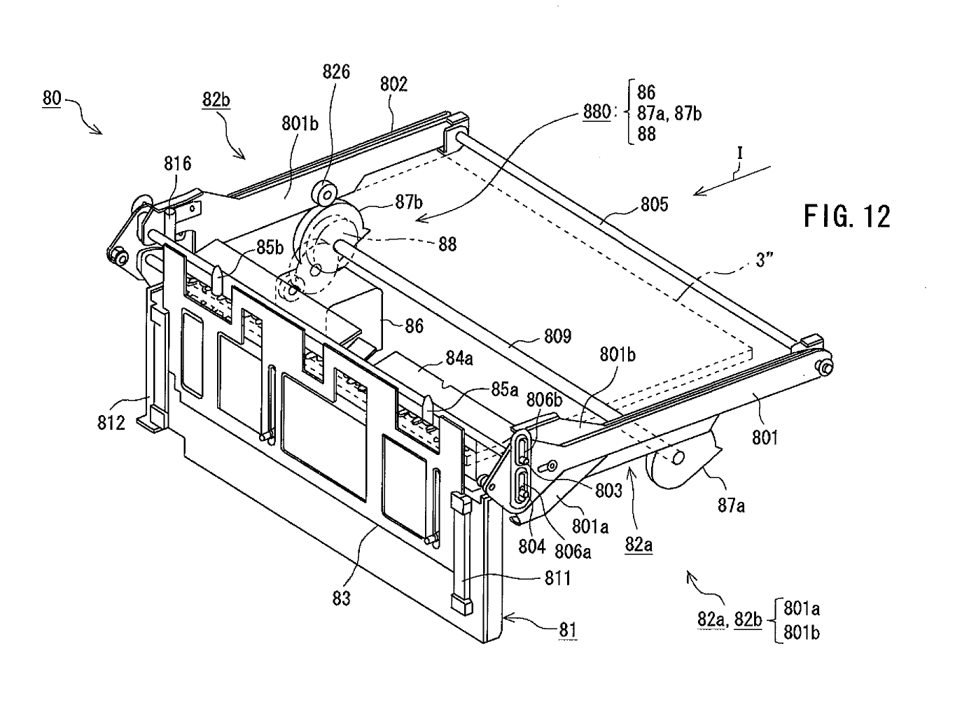

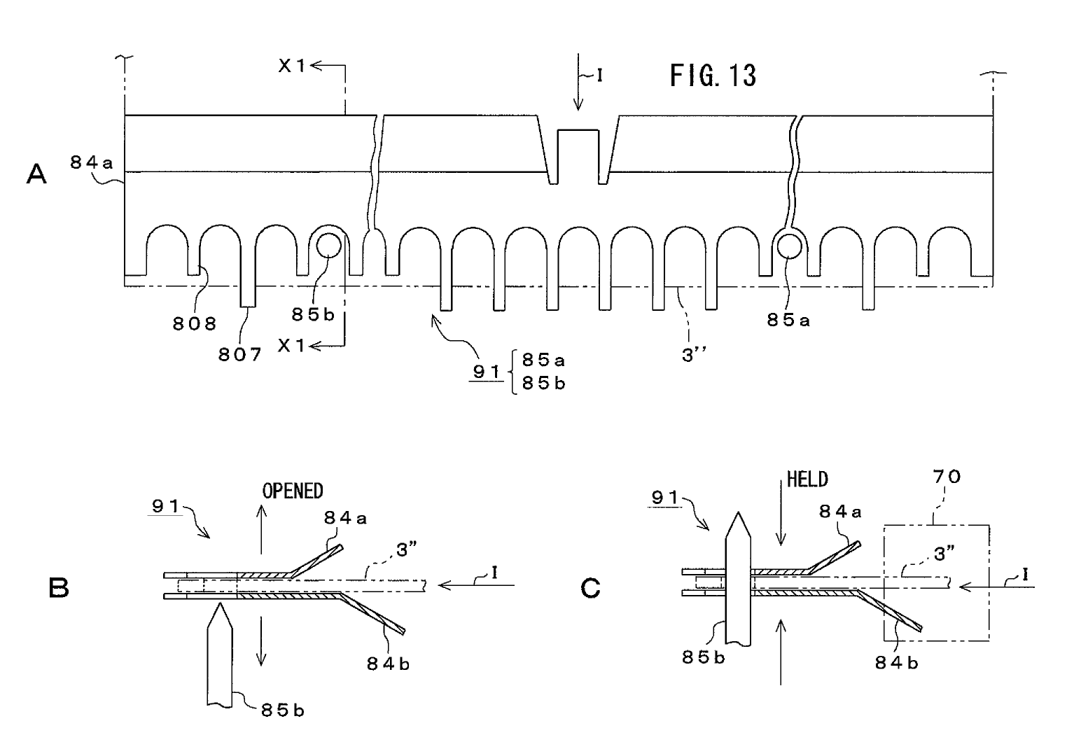

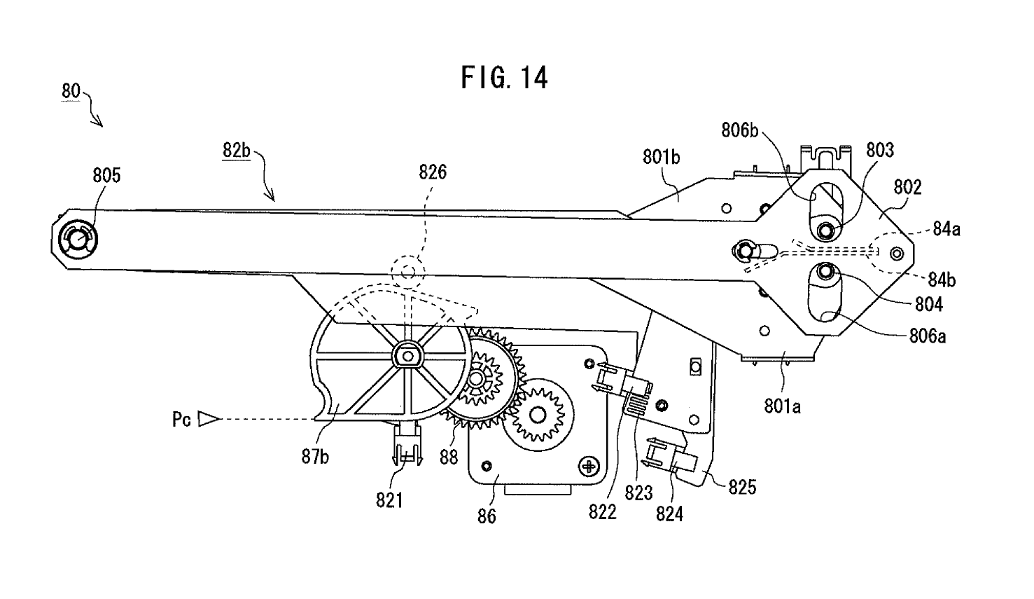

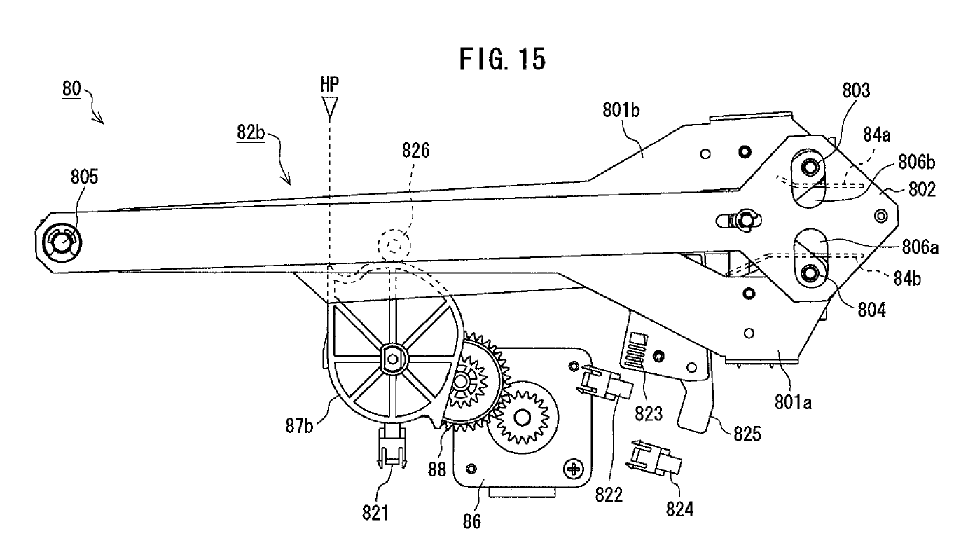

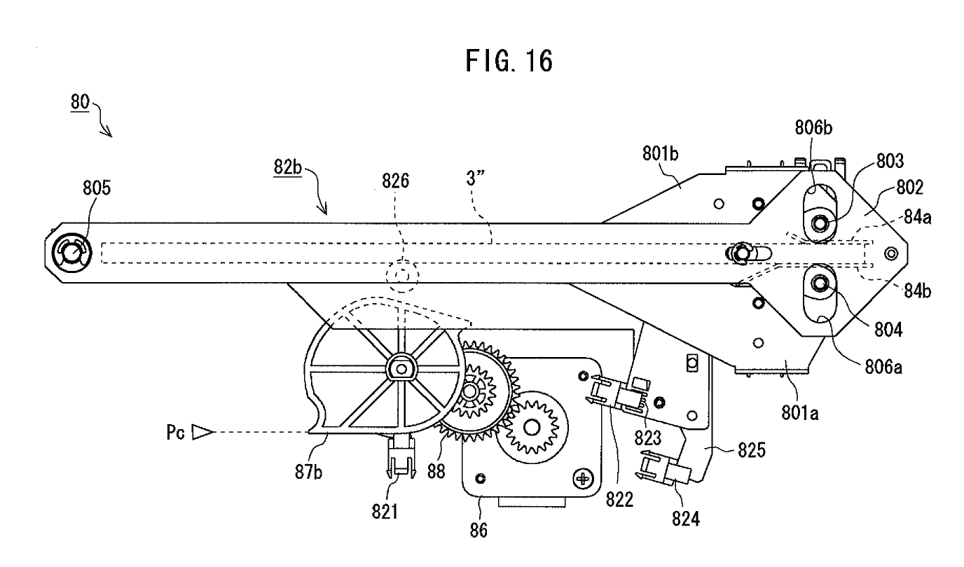

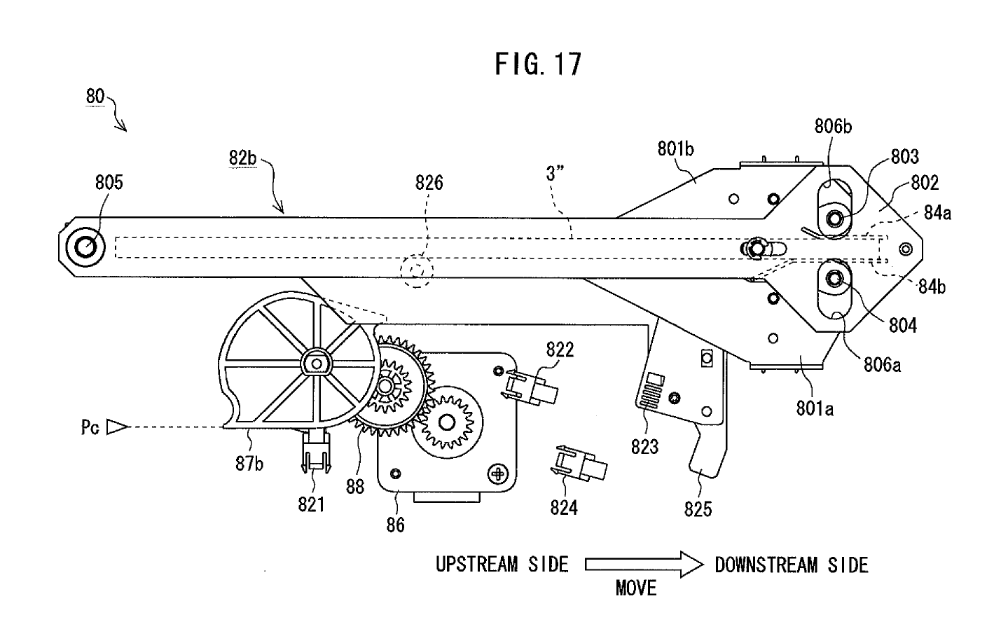

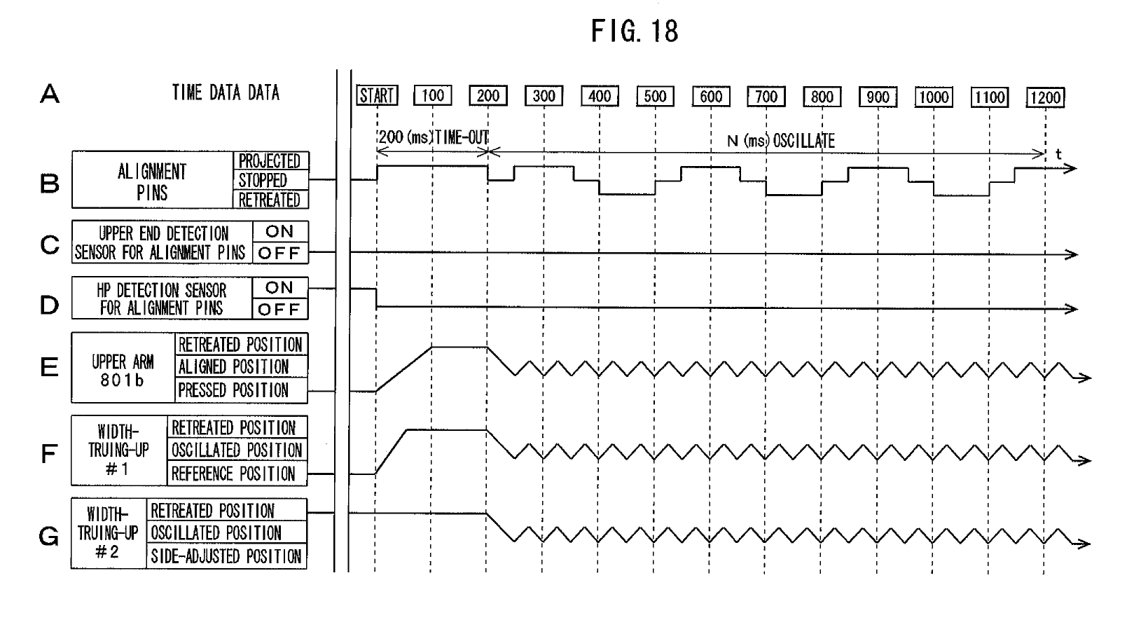

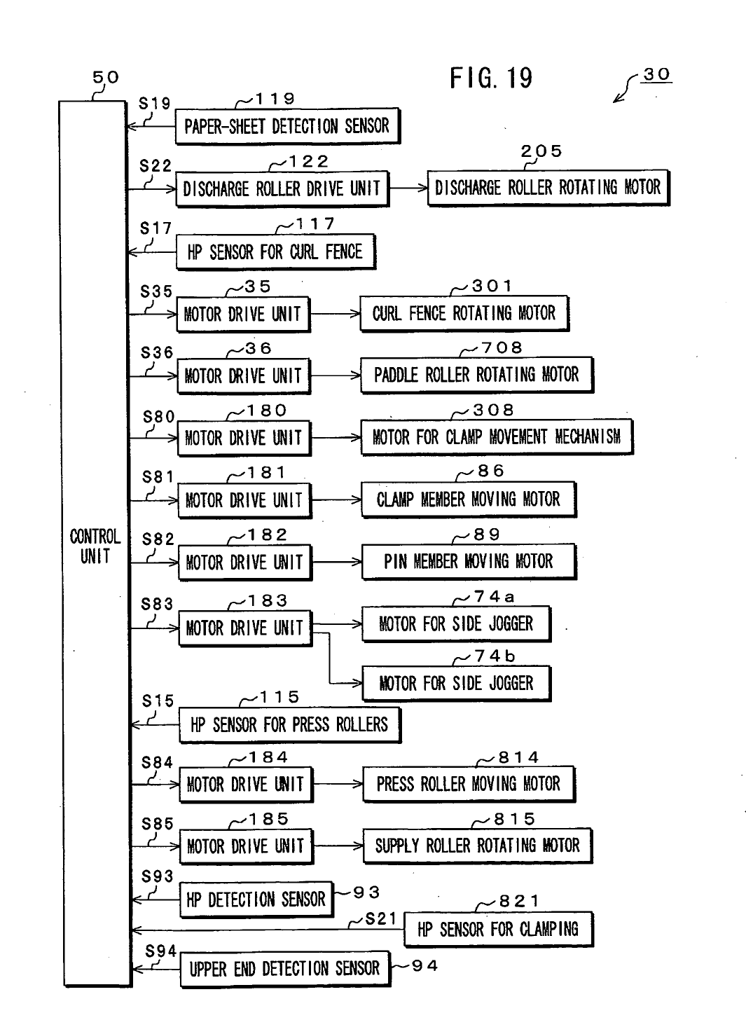

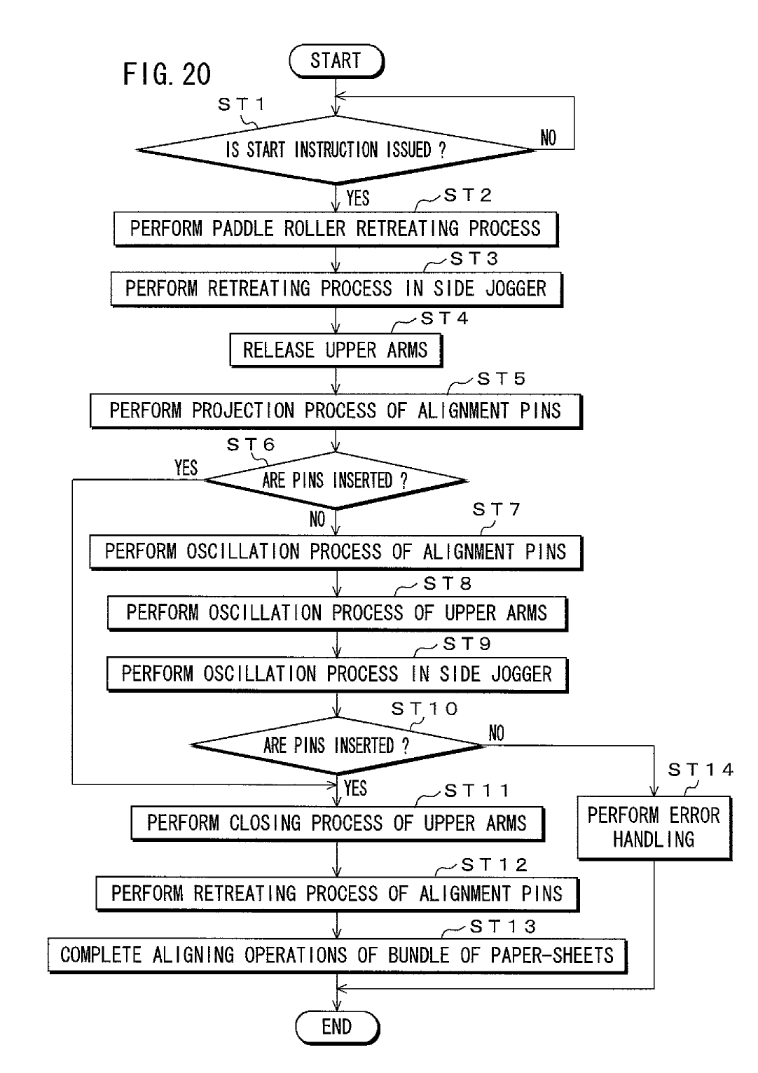

### BRIEF DESCRIPTION OF DRAWINGS

[FIG. 1] is a conceptual diagram showing a configuration example of a binding device 100 to which a paper-sheet handling device as an embodiment according to the present invention is applied.

[FIGS. 2A through 2D] are process diagrams showing a function example of the binding device 100.

[FIG. 3] is a perspective diagram showing a configuration example of a binder paper alignment unit 30.

[FIG. 4] is a perspective diagram showing a configuration example of a paper-sheet-curl-pressing mechanism 31 and peripheral equipment thereof.

[FIG. 5] is a perspective diagram showing a configuration example of a side jogger 70 as a first embodiment in the binder paper alignment unit 30.

[FIG. 6] is a diagram showing a configuration example of the side jogger 70 viewed from an upper surface thereof.

[FIG. 7] is a partially-sectional front view of the side jogger 70 for showing an operation example thereof.

[FIG. 8] is a perspective diagram showing a configuration example of an alignment-pin-driving mechanism 91.

[FIGS. 9A and 9B] are conceptual diagrams showing an example of a positional relationship between alignment pins 85a, 85b and punched holes 3a in paper-sheets.

[FIG. 10] is a perspective diagram showing an operation example of the alignment-pin-driving mechanism 91 before the pins are inserted.

[FIG. 11] is a perspective diagram showing an operation example of the alignment-pin-driving mechanism 91 after the pins are inserted.

[FIG. 12] is a perspective diagram showing a configuration example of a clamp movement mechanism 80 as a second embodiment in the binder paper alignment unit 30.

[FIG. 13A] is a top plan view of comb-shaped pressing members 84a, 84b for showing a configuration example thereof; FIG. 13B is a sectional view, taken along arrows X1-X1, for showing the alignment-pin-driving mechanism 91 before the alignment pins 85a, 85b are inserted; and FIG. 13C is a sectional view, taken along arrows X1-X1, for showing the alignment-pin-driving mechanism 91 after the alignment pins 85a, 85b are inserted.

[FIG. 14] is a front view of the clamp movement mechanism 80 showing an operation example (part one) when aligning a bundle of paper-sheets herein.

[FIG. 15] is a front view of the clamp movement mechanism 80 showing an operation example (part two) when aligning the bundle of paper-sheets herein.

[FIG. 16] is a front view of the clamp movement mechanism 80 showing an operation example (part three) when aligning the bundle of paper-sheets herein.

[FIG. 17] is a front view of the clamp movement mechanism 80 showing an operation example (part four) when aligning the bundle of paper-sheets herein.

[FIGS. 18A through 18G] are time charts showing a control example of oscillation in the binder paper alignment unit 30.

[FIG. 19] is a block diagram showing a configuration example of a control system in the binder paper alignment unit 30.

[FIG. 20] is a flowchart showing a control example of the binder paper alignment unit 30.

### BEST MODE FOR CARRYING OUT THE INVENTION

The present invention has on object to provide a paper-sheet handling device that enables the insertion resistance to be reduced when inserting these bar-shaped bodies into the perforated hole portions in the paper-sheets at a moment of aligning the bundle of paper-sheets and allows the hole portions to be aligned smoothly and instantaneously.

The following will describe embodiments of the paper-sheet handling device according to the present invention with reference to the drawings. The binding device 100 shown in FIG. 1 constitutes one example of the paper-sheet handling device and performs a punching process on recording paper (hereinafter, merely referred to as paper-sheet 3) released from a copy machine or a print machine, aligns positions of the hole portions perforated respectively at predetermined positions, and binds a plurality of paper-sheets 3 into a bundle of paper-sheets. The binding device 100 then performs a binding process by a predetermined binding component (consumables) 43 and releases it.

The binding device 100 has a main body (a case) 101 of the device. The binding device 100 is preferably used so as to be arranged next to the copy machine, the print machine (image-forming device) or the like and the main body 101 of the device has a height that is the same as that of the copy machine, the print machine or the like. A paper-sheet carrying unit 10 constituting an example of a paper-sheet carrying means is provided in the device body portion 101. The paper-sheet carrying unit 10 has a first carriage path 11 and a second carriage path 12. The carriage path 11 has a paper-feed inlet 13 and an outlet 14 and has a through-pass function for carrying the paper-sheet 3 drawn from the paper-feed inlet 13 toward the outlet 14 that becomes the predetermined position.

Here, the through-pass function is referred to as a function such that the carriage path 11 positioned between a copy machine, a printing machine or the like on the upstream side and other paper-sheet handling device on the downstream side directly delivers the paper-sheet 3 from the copy machine, the printing machine or the like to the other paper-sheet handling device. In a case in which the through-pass function is selected, it is configured that the acceleration process of the transport rollers, the binding process or the like is omitted. The paper-sheet 3, usually, in case of one-side copy, is delivered in a state of the face down. It is configured that a paper feed sensor 111 is mounted on the paper-feed inlet 13 so as to output a paper feeding detection signal to a control unit 50 by detecting a front edge of the paper-sheet 3.

The carriage path 12 has a switchback function by which the carriage path is switchable from the aforesaid carriage path 11. Here, the switchback function is referred to as a function that decelerates and stops the carriage of the paper-sheet 3 at a predetermined position of the carriage path 11, thereafter, switches the carriage path of the paper-sheet 3 from the carriage path 11 to the carriage path 12, and also, delivers the paper-sheet 3 in the reverse direction. It is configured that a flap 15 is provided in the carriage path 11 to switch the carriage path from the carriage path 11 to the carriage path 12.

Also, three cooperative transport rollers 17c, 19a′, 19a are provided at a switch point between the carriage path 11 and the carriage path 12. The transport rollers 17c and 19a rotate clockwise and the transport roller 19a′ rotates counterclockwise. For example, it is constituted such that the transport roller 19a′ is a drive roller and the transport rollers 17c and 19a are driven rollers. The paper-sheet 3 taken by the transport rollers 17c and 19a′ decelerates and stops, but when the flap 15 is switched from the upper position to the lower position, the paper is carried to the carriage path 12 by being fed by the transport rollers 19a′ and 19a. It is configured that a paper-sheet detecting sensor 114 is disposed just before the three cooperative transport rollers 17c, 19a′ and 19a, detects the front end side and the rear end side of the paper-sheet, and outputs a paper-sheet detection signal, not shown, to the control unit 50.

A punching process unit 20 is arranged on the downstream side of the carriage path 12. In this embodiment, it is designed so as to have a predetermined angle between the above-mentioned carriage path 11 and carriage path 12. For example, a first depression angle θ1 is set between a carrying surface of the carriage path 11 and a paper-sheet surface to be perforated of the punching process unit 20. Here, the paper-sheet surface to be perforated is referred to as a surface where holes are perforated in the paper-sheet 3. The punching process unit 20 is arranged so that the paper-sheet surface to be perforated can be set to a position having the depression angle θ1 on the basis of the carrying surface of the carriage path 11.

In the punching process unit 20, it is configured that two or more holes for the binding (hereinafter, referred to as punched holes 3a, and see FIG. 2B) are perforated at the one end of the paper-sheet 3 which switchbacks from the carriage path 11 and is carried by the carriage path 12. The punching process unit 20 has, for example, a motor 22 that drives a shuttle operable punch blade 21. The paper-sheets 3 are perforated by the punch blade 21 driven by the motor 22 for every sheet.

An openable and closable fence 24 that becomes a reference of the perforation position is provided in the punching process unit 20 and is used so as to strike the paper-sheet 3 thereto. Further, it is configured that a side jogger 23 is provided in the punching process unit 20 so that the posture of the paper-sheet 3 is corrected. For example, a front edge of the paper-sheet 3 is made to be attached uniformly to the openable and closable fence 24. The fence 24 becomes a positional reference at the time of aligning the paper-sheet edge portion. It is configured that a paper-sheet detecting sensor 118 is disposed just before the side jogger 23, detects the front end and the rear end of the paper-sheet, and outputs a paper-sheet detection signal, not shown, to the control unit 50.

The punching process unit 20 stops the paper-sheet 3 by attaching it to the fence 24 and thereafter, perforates the front edge of the paper-sheet 3. It should be noted that there is provided with a punch scrap storing unit 26 on the lower side of the punching processing main body and the punch scrap cut off by the punch blade 21 is made to be stored therein. It is configured that a discharge roller 25 is provided on the downstream side of the punching process unit 20 and carries the paper-sheet 3′ after the paper-sheet perforation (see FIG. 2B) to the unit of the succeeding stage.

It is configured that a binder paper alignment unit 30 constituting an example of paper-sheet holding means is arranged on the downstream side of the punching process unit 20 and holds (stores) temporarily a plurality of paper-sheets 3′ (see FIG. 2) which are paper-outputted from the punching process unit 20 with the positions of the punched holes therein being aligned. The binder paper alignment unit 30 is arranged so as to set a paper-sheet holding surface at the position having a second depression angle θ2 by making a carrying surface of a carriage unit 11 to be a reference. Here, the paper-sheet holding surface is referred to as the surface that holds (stacks) paper-sheets 3′ in each of which the punched holes are perforated. In this embodiment, a relation between the depression angle θ1 and the depression angle θ2 is set as θ1<θ2. With respect to the depression angle θ1, it is set as 0 degrees<θ1<45 degrees and with respect to the depression angle θ2, it is set as 0 degrees<θ2<90 degrees, respectively. This setting is for miniaturizing a width of the main body device 101 and for carrying the paper-sheet 3 in a straight way under this condition.

The binder paper alignment unit 30 has a paper-sheet-curl-pressing mechanism 31. it is configured that the paper-sheet-curl-pressing mechanism 31 is arranged in the unit 30 near a paper-sheet entry port and guides the paper-sheet 3′ to a predetermined position (a paper-sheet-holding unit 32 or the like) in the binder paper alignment unit 30 when the paper enters as well as takes over an operation to push a rear end side of the paper-sheet 3′ on the paper-sheet 3′ in front and behind at a moment of the completion of entering the paper.

Further, the binder paper alignment unit 30 has a width-aligning function on forward ends and end portions of paper-sheets. In this embodiment, the unit 30 is provided with a rotary member with multi-puddles (hereinafter, referred to as a paddle roller 37) which butts the forward end of the paper-sheet 3′ against the reference position and trues up side ends thereof to align the bundle of paper-sheets when entering the paper. The binder paper alignment unit 30 has a clamp movement mechanism 80 constituting an example of a paper-sheet fixing and carriage mechanism. It is configured that the clamp movement mechanism 80 holds a bundle of paper-sheets 3″ (see FIG. 3C) in which paper-sheets after the holes are perforated in the paper-sheet are stacked by a clamp member and moves it to a paper-sheet carriage direction. It is configured that, on a lower side of the binder paper alignment unit 30, a binding process unit 40 is provided and binds the plurality of paper-sheets 3″ aligned by the unit 30 with a binding component 43 to create a booklet 90. The booklet 90 is referred to as a bundle of bound paper-sheets 3″ into which the binding component 43 is caught (see FIG. 2D).

In the embodiment, the binding process unit 40 has a movement mechanism 41. The movement mechanism 41 moves to shuttle between the carriage direction of the paper-sheets in the binder paper alignment unit 30 and a position perpendicular to the carrying direction in the above-mentioned carriage unit 11 in a revolving way. The binding process unit 40 has the binder (binding component) cassette 42. The plurality of binding components 43 are set in the binder cassette 42. The binding component 43, for example, is made in the injection molding and a plurality of kinds thereof in response to the thickness of the bundle of paper-sheets is prepared.

The movement mechanism 41, for example, pulls out one piece of binding components 43 from the binder cassette 42 at the position perpendicular to the carriage direction of the carriage path 11 and holds it and in this state, the movement mechanism 41 rotates to a position from which the paper-sheet carriage direction of the binder paper alignment unit 30 can be looked over. At this position, the binding process unit 40 receives the bundle of paper-sheets 3″ whose punch holes 3a are position-determined from the binder paper alignment unit 30 and inserts the binding component 43 into the punch holes thereof to execute the binding process (automatic book-making function).

It is configured that in the downstream side of the binding process unit 40, a release unit 60 is arranged and the release processing for the booklet 90 produced by the binding process unit 40 is carried out. The release unit 60 is constituted so as to include, for example, a first belt unit 61, a second belt unit 62, and a stacker 63. It is configured that the belt unit 61 receives the booklet 90 that is dropping from the binder paper alignment unit 30 and switches the delivery direction thereof. For example, it is configured that the belt unit main body is turned around toward a predetermined release direction from the position from which the paper-sheet carrying direction of the binder paper alignment unit 30 can be looked over.

It is configured that the belt unit 62 constitutes an example of a booklet-carrying unit and receives the booklet 90 whose delivery direction is switched by the belt unit 61 to carry it in the relay manner. It is configured that the stacker 63 constitutes an example of a booklet-accumulating unit and accumulates the booklets 90 carried by the belt units 61 and 62.

Subsequently, a paper-sheet processing method according to the present invention will be explained with reference to FIG. 2. The paper-sheet 3 shown in FIG. 2A is one which is paper-fed from the upstream side of the aforesaid binding device 100 and one in which punched holes 3a are not perforated. The paper-sheet 3′ is carried directed to a predetermined position of the carriage path 11 shown in FIG. 1 and is decelerated and stopped at a predetermined position of the carriage path 11. Thereafter, the carriage path of the paper-sheet 3′ is switched from the carriage path 11 to the carriage path 12 and also, the paper-sheet 3 is delivered in the reverse direction and is carried to the punching process unit 20.

In the punching process unit 20, a predetermined number of punched holes 3a is perforated at one edge of the paper-sheet 3 as shown in FIG. 2B. The paper-sheet 3′ perforated with the punched holes 3a for the binding is carried to the binder paper alignment unit 30. When reaching a preset quantity of the paper-sheets 3a to form a bundle of paper-sheets 3″ as shown in FIG. 2C, it is configured that in the binder paper alignment unit 30, the positions of the punched holes 3a for the binding thereof are aligned and the binding component 43 is inserted into the punched holes 3a thereof under the cooperation of the binding process unit 40. This enables the booklet 90, as shown in FIG. 2D, inserted with the binding component 43 to be obtained.

Next, a description will be given of a configuration example of the binder paper alignment unit 30, the paper-sheet-curl-pressing mechanism 31, and a peripheral mechanism with reference to FIGS. 3 and 4. The binder paper alignment unit 30 shown in FIG. 3 stays in a condition where a shutter 83 is open so that a plurality of paper-sheets 3′ carried by the paper-sheet carrying unit 10 shown in FIG. 1 may butt against a reference position to align the punched holes 3a in the bundle of paper-sheets 3″ and stack them and temporarily hold them. The binder paper alignment unit 30 has a paper-sheet-holding unit 32. The binder paper alignment unit 30 has the paper-sheet-curl-pressing mechanism 31 near a paper-sheet inlet. It is configured that the paper-sheet-curl-pressing mechanism 31 guides the incoming paper-sheet 3′ to the paper-sheet-holding unit 32 and takes over an operation to push a rear end side of the paper-sheet 3′ on the paper-sheet 3′ in front and behind at a moment of the completion of entering the paper. The paper-sheet-holding unit 32 accumulates the paper-sheets 3′ and temporarily holds them. Across the paper-sheet outlet, a bundle-of-paper-sheets-carrying path I is configured (see FIG. 9).

Near the paper-sheet outlet in the paper-sheet-holding unit 32, the shutter 83 which constitutes an example of the bundle-of-paper-sheets carriage opening-and-closing mechanism is mounted so that the bundle-of-paper-sheets-carrying path I may be closed when aligning the bundle of paper-sheets. Inside the shutter 83 (on the side of the paper-sheet-holding unit 32), a clamp member configured of a movable upper arm 801b in the clamp movement mechanism 80 and a fixed lower arm 801a therein is opened, in which condition the paper-sheets 3′ are bound. When discharging the paper-sheets, the shutter 83 is opened to deliver the paper-sheets to the next process in a condition where they are sandwiched between the upper arm 801b and the lower arm 801a.

The paper-sheet-curl-pressing mechanism 31 shown in FIG. 4 is shown as being taken out of the binder paper alignment unit 30 shown in FIG. 3 and is provided with curl fence units 34a and 34b, rear guide units (introduction guides) 304a and 304b (see FIG. 3), curl guide units (travel guides) 305a and 305b and the like.

On the right and left sides of a position near the paper-sheet inlet in the paper-sheet-holding unit 32, the curl fence units 34a and 34b are mounted respectively. The curl fence units 34a and 34b operate to hold down the rear end side of the paper-sheet 3′ guided by the rear guide units 304a and 304b and receive the front end side of the next paper-sheet 3′. The right and left curl fence units 34a and 34b are mounted on a power transmission shaft (curl fence shaft) 307. To one end of the power transmission shaft 307, a motor 301 is mounted via a decelerating gear 309. The motor 301 constitutes an example of the driving unit and rotates the curl fence units 34a and 34b in a predetermined direction.

The curl fence unit 34a is configured to have a disk-shaped rotary body portion 341 and a plurality of protrusions 342. The rotary body portion 341 has a shaft portion 341a. To the shaft portion 341a, the power transmission shaft 307 is mounted. Along a circumferential portion of the rotary body portion 341, the four protrusions 342 are disposed, for example, at every 90 degrees. The protrusions 342 each has a shape to protrude in parallel to the shaft portion 341a. By thus configuring the curl fence unit 34a, it is possible to hold the curled paper 3′ down by its protrusions 342 when the paper-sheets are aligned and held temporarily.

For example, each time a paper-sheet comes in, the protrusions 342 circulate upward, thereby enabling keeping a state where the curled site of the paper-sheet 3′, being stacked, is held down. It is to be noted that the curl fence unit 34b has the same configuration regarding structure and functions as the curl fence unit 34a and functions similar to it, an explanation of which will be omitted.

Near the right and left curl fence units 34a and 34b, the rear guide units 304a and 304b shown in FIG. 3 are provided. The rear guide units 304a and 304b are arranged to guide the front edge of the paper-sheet 3′ coming into this binder paper alignment unit 30 in a predetermined direction.

The above-mentioned rear guide units 304a and 304b have a rotatable structure in which they have a spatula-shaped projecting strip, not shown. This rotary structure enables guiding the paper-sheet 3′ up to a position just near the curl fence units 34a and 34b, so that the incoming paper-sheet 3′, even if curled, can be prevented from colliding violently with the curl fence units 34a and 34b, thereby avoiding jamming due to this collision.

Below the power transmission shaft 307 connecting the above-mentioned curl fence units 34a and 34b, the curl guide units 305a and 305b are mounted. The curl guide units 305a and 305b are arranged to guide the paper-sheet 3′ guided by the rear guide units 304 toward the paper-sheet-holding unit 32. The curl guide units 305a and 305b have such a structure that they may be fixed to a position separate from a paper-sheet alignment surface of the paper-sheet-holding unit 32. For example, the curl guide units 305a and 305b are fixed to a couple of guide support bars 303a and 303b which are stretched across the paper-sheet inlet over the right and left thereof.

An upper guide 310 is mounted to the guide support bar 303b and is arranged to guide the paper-sheet 3′ to the paper-sheet-holding unit 32 with it's the bottom portion being held. The curl guide units 305a and 305b are, for example, made of injection-molded resin and each has an arc-shaped R-surface of the bottom portion as viewed from the top. They measure about 20 to 30 ml in width and 60 to 80 mm in length. They stand about 8 to 10 ml in height. Thus, if the curled paper-sheet 3′ comes in, rising power of such a paper-sheet 3′ can be relaxed, thus enabling jamming due to the incoming of the curled paper-sheet 3′ to be avoided.

The above-mentioned rear guide unit 304a has a cam 311 which is interlocked with the curl fence unit 34a. It is configured to retreat (retreat) from the rotary trajectory of the curl fence unit 34a by the driving of the cam 311 upon completion of incoming of a paper-sheet. For example, the cam 311 of the rear guide unit 304a is combined to the curl fence unit 34a via a follower ring so as to be interlocked with the rotation thereof. Thus, as the curl fence unit 34a rotates, the rear guide unit 304a also swings simultaneously and, upon completion of the incoming of a paper-sheet, retreats from the rotary trajectory of the curl fence unit 34a, thus enabling preventing itself from coming in contact with the protrusions. Moreover, since the rear guide unit 304a is made rotatable, such a guide can be configured up to the position just near the curl fence units 34a, thereby avoiding jamming. It is to be noted that in terms of the cam 311 and the follower ring, the curl fence unit 34b also has the same configuration as the curl fence unit 34a and functions similar to it, an explanation of which will be omitted.

To the other end of the above-mentioned power transmission shaft 307, a disk 307a having a predetermined shape (four leaves shape in this example) is mounted which is used to detect a curl fence home position. At a position for engagement with this disk 307a, a sensor (hereinafter referred to as an HP sensor 117) is mounted which is used to detect the curl fence home position (see FIG. 19). It is configured that the HP sensor 117 detects a stop position of the curl fence units 34a and 34b which are rotated by the motor 301. As the HP sensor 117, a transmission type optical sensor (light emitting and photoreceptor element) is used.

Inside the paper-sheet outlet in the paper-sheet-holding unit 32 shown in FIG. 3, a side jogger 70 (width-truing-up mechanism) shown in FIG. 4 which constitutes an example of the guide member for truing up widths is provided, so that when aligning the bundle of paper-sheets 3″, the bundle of paper-sheets 3″ is pressed by the width-truing-up member from both sides to true up the widths of a plurality of the paper-sheets 3′ (first pre-alignment process). The first pre-alignment process is a paper-sheet end alignment process by aligning the side ends of a plurality of the paper-sheets 3′.

In this example, it is configured that on the downstream side of the side jogger 70, that is, near the paper-sheet outlet in the unit body, an alignment-pin-driving mechanism 91 (see FIG. 8) is mounted and realigns the bundle of paper-sheets 3″ by utilizing the punched holes 3a perforated in the paper-sheet 3′ (second pre-alignment process). The second pre-alignment process is a paper-sheet front edge alignment process by re-aligning the front edges of the paper-sheets in the bundle 3″ thereof. It is configured that when taking out paper-sheets, the width-truing-up members of the side jogger 70 retreat to both sides of the bundle of the paper-sheets 3″. This is done so in order to give any room to the bundle-of-paper-sheets-carrying path I (see FIGS. 5 to 7).

Inside the paper-sheet outlet in the paper-sheet-holding unit 32, besides the side jogger 70, a supply roller (not shown) and press rollers 33 are disposed so that the bundle of paper-sheets 3″ may be pressed from the upper and lower sides respectively when the bundle of paper-sheets 3″ is discharged to the next step. At the paper-sheet outlet, the shutter 83 is provided, which operates to open and close the bundle-of-paper-sheets-carrying path I. For example, it is configured that if the shutter 83 is opened, with the above-mentioned supply roller (not shown) and press rollers 33, the bundle of paper-sheets 3″ is carried (discharged) along the bundle-of-paper-sheets-carrying path I. By thus configuring the rollers for taking out paper-sheets, even in a case where the bundle of paper-sheets 3″ is not bound with the binding component 43, it is possible to carry the bundle of paper-sheets 3″ to the next step in a condition where they are kept as a bundle.

### Embodiment 1

Subsequently, a description will be given of a configuration example of the side jogger 70 as a first embodiment in the binder paper alignment unit 30 with reference to FIGS. 5 and 6. In this embodiment, the side jogger 70 is configured so that a width-truing-up reference guide 72b which provides an end surface reference for the paper-sheet 3′ and a width-truing-up guide 72a which presses each of the paper-sheets 3′ against the width-truing-up reference guide 72b are disposed in a condition where they may face each other in a paper-sheet width direction, so that the width-truing-up guide 72a and the width-truing-up reference guide 72b may be driven independently of each other. It is configured that, for example, the side jogger 70 aligns the paper-sheets 3′ by pressing each of them against the reference side. It is thus possible to true up the widths of the paper-sheets 3′ temporarily held in the binder paper alignment unit 30 (paper-sheet end alignment process).

The side jogger 70 shown in FIG. 5 is equipped in the binder paper alignment unit 30 shown in FIG. 4. The side jogger 70 is configured to have a body housing portion 71, the width-truing-up guide 72a, the width-truing-up reference guide 72b, rails 73a and 73b, motors 74a and 74b, and movable stages 75a and 75b. The body housing portion 71 is configured to have an upper surface site and a back surface site. The body housing portion 71 is formed into a box-like body by folding back an iron plate. The upper surface site of the box-like body is open. In this embodiment, the back surface site of the body housing portion 71 is arranged to be regions where the motors are to be installed. Its upper surface site is arranged to be a region for the movable stages.

In the region for the movable stages, the width-truing-up guide 72a, the width-truing-up reference guide 72b, the rails 73a and 73b, and the movable stages 75a and 75b are disposed. For example, the rails 73a and 73b are disposed in such a manner as to bridge the two wall surfaces inside the body housing portion 71. The rails 73a and 73b are mounted so that two round rods are attached to positions going through the right-side end and the left-side end of the body housing portion 71 respectively. With the rails 73a and 73b, the couple of movable stages 75a and 75b are engaged in such a manner that they can be moved in the right-and-left direction.

The movable stages 75a and 75b are made of, for example, molded resin and have openings (not shown) that are formed therein in such a manner as to pass through in the right-and-left direction, so that through these openings, the rails 73a and 73b may pass. Of course, the rails 73a and 73b are not limited to an aspect that they may pass through the openings but may be of such an aspect that the movable stages 75a and 75b may be fitted with a drive wheel so as to travel on the rails 73a and 73b.

The movable stage 75b is fitted with the width-truing-up reference guide 72b at its upper left end, while the movable stage 75a is fitted with the width-truing-up guide 72a at its upper right end. As the width-truing-up guide 72a and the width-truing-up reference guide 72b, for example, an iron plate which is folded back into a deformed U-shape and treated may be used. The width-truing-up guide 72a and the width-truing-up reference guide 72b are formed in such a manner that they may become larger on the upstream side and smaller on the downstream side in width. This is done so in order to guide the curled paper-sheet 3′ up to the forward end of the paper-sheet-holding unit 32 with a good reproducibility.

The upstream sides of the width-truing-up guide 72a and the width-truing-up reference guide 72b have shapes (flaps) whose upper end portion is jumped up and the downstream sides thereof have shapes which droop oppositely in order to guide paper. These shapes are formed to guide the paper-sheet 3′ sent over from the punching process unit 20 to the clamp movement mechanism 80 together with the paddle roller 37.

Further, in the motor installing regions arranged on the back surface site of the body housing unit 71, the motors 74a and 74b are installed. As the motors 74a and 74b, a stepping motor may be used respectively. The motors 74a and 74b are arranged so that their motor rotary shafts may pass from the back surface site through the upper surface site of the body housing unit 71. The motor rotary shaft of the motor 74a is fitted with a belt driving pulley 76a shown in FIG. 6, while the motor rotary shaft of the motor 74b is fitted with a belt driving pulley 76b (see FIG. 7).

On the side of the upper surface site of the body housing portion 71, driven pulleys 77a and 77b are mounted. Between the belt driving pulley 76a and the driven pulley 77a, a non-terminal belt 78a is engaged. Similarly, between the belt driving pulley 76b and the driven pulley 77b, a non-terminal belt 78b is engaged.

In this embodiment, such a configuration can be given that by engaging portions of the belts 78a and 78b with the movable stages 75a and 75b so as to enable belt-driving the movable stages 75a and 75b respectively, the width-truing-up guide 72a and the width-truing-up reference guide 72b can be moved in a direction perpendicular to the paper-sheet carrying direction.

Although the above-mentioned embodiment has been described with reference to the case of mounting the motors 74a and 74b separately from each other on the back surface site of the body housing portion 71, the present invention is not limited to it; the motors 74a and 74b may be mounted close to each other to the positions on the back surface site that correspond to those of the driven pulleys 77a and 77b respectively or only one of the motors 74a and 74b may be mounted to the position on the back surface site that corresponds to that of the driven pulleys 77a or 77b respectively. By thus working out the layout of the motors 74a and 74b, the component mounting space can be reserved, thereby miniaturizing the binding device 100.

Subsequently, a description will be given of an example of the operations of the side jogger 70 with reference to FIG. 7. According to the side jogger 70 shown in FIG. 7, by reciprocating the belts 78a and 78b as shown in FIG. 6 by, for example, rotating the motors 74a and 74b in the normal and reverse directions, it is possible to move the movable stages 75a and 75b shown in FIG. 7 in the right and left directions separately from each other which are fixed to the belts 78a and 78b on the approach route side.

By moving the movable stages 75a and 75b in the right and left directions, it is possible to individually vibrate the width-truing-up guide 72a and the width-truing-up reference guide 72b in the right and left direction on the right and left sides separately from each other. By controlling the number of steps of the motors 74a and 74b etc., it is possible to select a swinging position in such a manner as to match the width of the paper-sheet 3′. For example, to accommodate a difference in paper-sheet width between the A4-size paper-sheet 3′ and the B5-size paper-sheet 3′, by changing the number of motor steps which matches the A4-size paper-sheet width to that which matches the B5-size paper-sheet width, the swinging position can be changed. In such a manner, it is possible to hold the bundle of paper-sheets 3″ again with its hole positions being aligned by swinging the both sides of the bundle of paper-sheets 3″ at a predetermined position immediately before inserting the binding component 43 through the bundle of paper-sheets 3″ and inserting alignment pins 85a and 85b as shown in FIG. 8.

In this embodiment, when the alignment pins 85a and 85b are inserted into the punched holes 3a in the bundle of paper-sheets 3″ or before the alignment pins 85a and 85b are inserted into the punched holes 3a in the bundle of paper-sheets 3″, the side jogger 70 is configured so as to retreat from the bundle-of-paper-sheets-carrying path I. It is thus possible to give a room between the bundle of paper-sheets 3″ and the side jogger 70 when aligning the bundle of paper-sheets to get the punched holes 3a in the bundle of paper-sheets 3″ in a line, thus avoiding a situation in which the bundle of paper-sheets 3″ may be sandwiched between the side jogger 70 and the alignment pins 85a and 85b.

Next, a description will be given of a configuration example of the alignment-pin-driving mechanism 91 with reference to FIG. 8. The alignment-pin-driving mechanism 91 shown in FIG. 8 is shown as being extracted from the binder paper alignment unit 30 shown in FIG. 3, to realign the bundle of paper-sheets 3″ having the punched holes 3a with respect to these punched holes 3a (paper-sheet front edge alignment process). The bundle of paper-sheets 3″ shown in FIG. 8 stays in a condition where it is clamped by the clamp movement mechanism 80 via an upper shaft 803 and a lower shaft 804 before the pin alignment (second paper-sheet process device).

The alignment-pin-driving mechanism 91 is equipped to a body board 900, which provides a base for the binder paper alignment unit 30 and a base for the clamp movement mechanism 80, and configured to have the alignment pins 85a and 85b, a motor 89, an alignment pin home position sensor (hereinafter referred to as an HP detection sensor 93), and an alignment pin upper end detection sensor (hereinafter referred to as an upper end detection sensor 94). The body board 900 is provided with a right edge frame 92a (right edge side surface frame) and a left edge frame 92b (left edge side surface frame) having predetermined shapes on both sides thereof respectively.

In this embodiment, the right edge frame 92a has two sliding grooves 921 and 922, while the left edge frame 92b has two sliding grooves 923 and 924. These sliding grooves 921 to 924 are used when moving the clamp movement mechanism 80 toward the downstream side independently of the body board 900 and the right-edge and left-edge frames 92a and 92b.

It is configured that the body board 900 is fitted with the motor 89 constituting drive means, which drives the alignment pins 85a and 85b upward and downward. As the motor 89, a DC motor may be used. The motor 89 is engaged with a decelerating gear 98 (gear unit), which converts the motor rotation number at a predetermined decelerating ratio. The decelerating gear 98 is engaged with an up-down rack member (hereinafter referred to as an UD rack 95), which moves up and down based on a torque converted at the predetermined decelerating ratio.

To one end of the UD rack 95, a plate 97 having a predetermined shape is connected. To the other end of the plate 97, arms 99a and 99b having predetermined shapes are engaged commonly around a rotary shaft. It is configured that the arms 99a and 99b may be opened in an X-shape or closed in a straight-line shape with respect to the rotary shaft.

In this embodiment, one end of each of the arms 99a and 99b is engaged with the body board 900 at its predetermined position in a rotatable and slidable manner. The other end of each of the arms 99a and 99b is engaged with a link 96 having a predetermined shape in a rotatable and slidable manner. The link 96 has, for example, an inverted π shape, so that the other end of the arm 99a is engaged with one end of the inverted π shape in a rotatable and slidable manner and the other end of the arm 99b is engaged with the other end thereof in a rotatable and slidable manner.

With one end portion of the link 96, the alignment pin 85a is engaged and with the other end portion of the link 96, the alignment pin 85b is engaged. The alignment pins 85a and 85b constitute one example of bar-shaped bodies for alignment, and it is configured that they align the punched holes 3a in the bundle of paper-sheets 3″ temporarily held in the paper-sheet-holding unit 32. For example, the alignment pins 85a and 85b are inserted into predetermined two of the punched holes 3a in the bundle of paper-sheets 3″.

It is to be noted that the HP detection sensor 93 is fitted to a predetermined position of the left edge frame 92b and detects a home position (lower edge) of each of the alignment pins 85a and 85b to output an HP detection signal S93. In the left edge frame 92b, the upper end detection sensor 94 is fitted to a predetermined position thereof above the HP detection sensor 93 and detects an upper edge position of each of the alignment pins 85a and 85b to output an upper end detection signal S94. By thus configuring the alignment-pin-driving mechanism 91 and rotating the motor 89, the alignment pins 85a and 85b can be driven up and down.

Next, a description will be given of an example of the positional relationship between the alignment pins 85a and 85b and the paper-sheet punched holes 3a with reference to FIGS. 9A and 9B. The shutter 83 shown in FIG. 9A has a reference position which may be formed when the bundle-of-paper-sheets-carrying path I is closed. The reference position is set on a surface of the shutter 83 on the side of the paper-sheet-holding unit 32. In this embodiment, a distance 51 is defined as a distance from the reference position of the shutter 83 up to a predetermined position of the alignment pins 85a and 85b. In this embodiment, it is defined as a distance from the shutter 83 surface of on the side of the alignment pins 85a and 85b up to a center position of the alignment pins 85a and 85b.

Further, defining S2 as a distance from the front edge of the paper-sheet 3′ shown in FIG. 9B up to a predetermined position of the punched holes 3a, in this embodiment, it means a distance from the front edge of the paper-sheet 3′ up to the center position of the punched holes 3a, and the alignment pins 85a and 85b are disposed so that a relationship of S1>S2 may be established with respect to the reference position of the shutter 83. That is, the alignment pins 85a and 85b are disposed at such a position that its distance with respect to the reference position of the shutter 83 may be larger than a dimension from the front edge of the paper-sheet up to the punched holes 3a.

For example, as the distance S2 from the front edge of the paper-sheet 3′ up to the center position of the punched holes 3a is 10 [mm], a room α of 0.5 [mm] may be provided to set the distance S1 from the reference position of the shutter 83 up to the pin center of the alignment pins 85a and 85b to be 10.5 [mm]. The room α is not limited to 0.5 [mm] but may be larger or smaller than this value. By setting such a dimension, it is possible to perform the pre-alignment process on the bundle of paper-sheets 3″ by use of the openable-and-closable shutter 83 and the alignment pins 85a and 85b which can be moved up and down (first paper-sheet handling device).

Subsequently, a description will be given of an example of operations of the alignment pins 85a and 85b in the alignment-pin-driving mechanism 91 with reference to FIGS. 10 and 11. In the example of the operations prior to pin insertion in the alignment-pin-driving mechanism 91 shown in FIG. 10, in order to make clear the description, the right edge frame 92a, the left edge frame 92b, the shutter 83, and the body board 900 are omitted in the figures.

In FIG. 10, the alignment pins 85a and 85b disposed to the home position (HP) thereof retreat to the outside of the bundle-of-paper-sheets-carrying path I during paper-sheets alignment operation. The HP detection sensor 93 detects the home position of the alignment pins 85a and 85b and outputs the HP detection signal S93 to the control unit 50 (see FIG. 19).

Further, according to the operation example during pin insertion in the alignment-pin-driving mechanism 91 shown in FIG. 11, at the time of pin alignment, the alignment pins 85a and 85b project out of the side of the fixing clamp member (lower frame 801a) in a condition where the movable clamp member (upper frame 801bis open. For example, if the motor 89 is turned ON and rotates in the clockwise direction at the home position shown in FIG. 10, the decelerating gear 98 rotates clockwise. If the decelerating gear 98 rotates clockwise, the UD rack 95 moves upward.

If the UD rack 95 moves upward, the rotary shaft of the arms 99a and 99b placed in the closed state is pulled upward. If the rotary shaft of the arms 99a and 99b is pulled upward, the arms 99a and 99b are opened in the X-shape. If the arms 99a and 99b are opened in the X-shape, the link 96 is pulled upward. If the link 96 is pulled upward, the alignment pins 85a and 85b are pulled upward. As a result, the alignment pins 85a and 85b pass through the punched holes 3a in the bundle of paper-sheets 3″. The upper end detection sensor 94 detects the upper end position of the alignment pins 85a and 85b and outputs the upper end detection signal S94 to the control unit 50 (see FIG. 19). It is thus possible to insert the alignment pins 85a and 85b into the punched holes 3a, thereby aligning the bundle of paper-sheets 3″.

In such a manner, according to the binding device 100 according to the first embodiment, in the case of providing the bundle of paper-sheets 3″ by aligning the position of punched holes 3a with respect to a plurality of the paper-sheets 3′ in which the punched holes 3a are formed at predetermined positions, the binder paper alignment unit 30 butts the plurality of paper sheets 3′ against the reference position and stack it and temporarily hold it. Based on this assumption, the alignment pins 85a and 85b disposed with respect to the reference position in the relationship of S1>S2 align the punched holes 3a in the plurality of paper-sheets 3′ temporarily held in the binder paper alignment unit 30.

Therefore, even if the end surface of the paper-sheet 3′ does not reach the reference position, this positional relationship may insert inserting the alignment pins 85a and 85b into the punched holes 3a, thus enabling avoiding a situation where the bundle of paper-sheets 3″ may be sandwiched between the reference position and the alignment pins 85a and 85b. It is thus possible to reduce an insertion resistance that may occur when inserting these alignment pins 85a and 85b into the punched holes 3a in the paper-sheets 3′, thus smoothly aligning the punched holes 3a in the bundle of stacked paper-sheets 3″ instantaneously even if these punched holes are formed irregularly in position.

In this embodiment, during the pre-alignment process, by causing the side jogger 70 to retreat, the insertion resistance that may occur when inserting these alignment pins 85a and 85b into the punched holes 3a in the paper-sheets 3′ can be reduced, thereby enabling the punched holes 3a in the bundle of stacked paper-sheets 3″ to be smoothly aligned instantaneously even if these punched holes are formed irregularly in position.

Further, to prevent the bundle of paper-sheets 3″ from being sandwiched, any control may be conducted to put the motors 74a and 74b etc. of the side jogger 70 in an unexcited state and cause the width-truing-up guide 72a and the width-truing-up reference guide 72b to retreat. Moreover, to prevent the bundle of paper-sheets 3″ from being sandwiched, the width-truing-up guide 72a, the width-truing-up reference guide 72b and the shutter 83 maybe made of an elastic substance such as rubber or soft resin so that the bundle of paper-sheets 3″, if sandwiched and deformed, could escape through it. It is to be noted that to carry out the paper-sheet front edge alignment process smoothly, a diameter of each of the alignment pins 85a and 85b may be decreased or a diameter of each of the punched holes 3a may be increased so that the bundle of paper-sheets 3″ might not be sandwiched with a large clearance between the punched holes 3a and the alignment pins 85a and 85b.

### Embodiment 2

Subsequently, a description will be given of a configuration example of the clamp movement mechanism 80 as a second embodiment in the binder paper alignment unit 30 with reference to FIG. 12. The clamp movement mechanism 80 shown in FIG. 12 constitutes an example of the paper-sheet fixing-and-carrying mechanism and operates to carry the bundle of paper-sheets 3″ with it being fixed. In this embodiment, it is configured that at the time of the bundle-of-paper-sheets alignment to align the punched holes 3a in the paper-sheets 3′, fixation of the bundle of paper-sheets 3″ is released and the pin alignment is performed thereon and then they move along a paper-sheet carriage direction from the paper-sheet-curl-pressing 31 toward the downstream side with the edge portion of the bundle of paper-sheets 3″ on the side of the punched holes being fixed.

The clamp movement mechanism 80 is configured to have a body board 81, a right-edge side clamp member (hereinafter merely referred to as a clamper 82a), a left-edge side clamp member (hereinafter merely referred to as a clamper 82b), the shutter 83, comb-shaped pressing members 84a and 84b (see FIG. 13B), and a clamp opening-and-closing drive unit 880. The clampers 82a and 82b respectively have the lower arm 801a which constitutes one example of the fixing clamp member and the upper arm 801b which constitutes one example of the movable clamp member. The upper arm 801b is arranged so that it can be moved upward and downward. In this embodiment, it is always urged by a spring in a closing direction in order to hold the bundle of paper-sheets 3″. The upper arm 801b stops after being opened to an arbitrary intermediate position which is a larger width than the thickness of the bundle of paper-sheets 3″ and is smaller than the height of the bundle-of-paper-sheets-carrying path I and waits here until it detects that the alignment pins 85a and 85b have reached the upper edge position by using the upper end detection sensor 94 shown in FIG. 11. The left-edge side clamper 82b is also configured similarly. It is to be noted that on the side of the lower arm 801a, the alignment-pin-driving mechanism 91 shown in FIG. 8 is mounted.

The clamp release-and-drive unit 880 is used to drive the upper arm 801b. For example, the clamp opening-and-closing drive unit 880 is configured to have a motor 86, cams 87a and 87b, and a gear unit 88 and releases the bundle of paper-sheets 3″ by moving the upper arm 801b to a predetermined position with respect to the lower arm 801a when aligning bundle of paper-sheets. The clamp opening-and-closing drive unit 880 operates to start moving the upper arm 801b with respect to the lower arm 801a simultaneously when the alignment-pin-driving mechanism 91 starts the insertion of the alignment pins 85a and 85b into the punched holes 3a in the paper-sheets 3′. Thus, a friction resistance between paper-sheets can be reduced. Further, by setting the intermediate position as the position where the upper arm 801b may retreat with respect to the lower arm 801a, the paper-sheets 3′ do not raise by the alignment pins 85a and 85b so that the bundle of paper-sheets can be aligned, thereby reducing irregularities in the condition of the paper-sheets 3′. Here, the intermediate position is referred to as a position between a clamp closing position and a clamp full-opening position.

The body board 81 on which the clamp opening-and-closing drive unit 880 is mounted is configured to have a front surface site and a side surface site. The body board 81 is made by folding back an iron plate and treating it so that the front surface site and the right and left surface sites may be formed. The left side surface site occupies a larger region than the right side surface site. In this embodiment, inside the left side surface site, a region is allocated to mount the motor, above the right side surface site, a region is allocated to mount the clamper 82a, and above the left side surface site, a region is allocated to mount the clamper 82b.

On the body board 81, the clampers 82a and 82b, the shutter 83, the comb-shaped pressing members 84a and 84b, the alignment pins 85a and 85b, the motor 86, the cams 87a and 87b, and the gear unit 88 are respectively disposed. At the upper parts on both sides of the body board 81, the clampers 82a and 82b are mounted movably and operate to hold and fix the bundle of paper-sheets 3″ and release it free. The clamper 82a is configured to have, for example, a sword-pointed clamp chassis 801 having a regulation hole formed in it.

The clamper 82a is configured to have the lower arm 801a and the upper arm 801b. With one end of the lower arm 801a, the lower shaft 804 is movably fitted. With one end of the upper arm 801b, the upper shaft 803 is movably fitted. The clamper 82b facing the clamper 82a is provided with a similarly constituted clamp chassis 802 having a regulation hole. The other ends of the above-mentioned lower arm 801a and upper arm 801b are movably engaged with a fulcrum shaft member 805 together with the other ends of the clamp chassis 801 and 802 having the regulation holes.

The clamp chassis 801 and 802 having the regulation holes have elongated openings 806a and 806b to regulate clamp opening and closing so that the upper shaft 803 and the lower shaft 804 may be regulated in movement. An assembly is performed so that the end portion of the lower shaft 804 may be exposed in the opening 806a and the end portion of the upper shaft 803 may be exposed in the opening 806b.

Next, a description will be given of a configuration example and operations example of the comb-shaped pressing members with reference to FIGS. 13A through 13C. With the above-mentioned upper shaft 803, the comb-shaped upper part pressing member 84a as shown in FIG. 13A is fitted and with the lower shaft 804, the comb-shaped lower part pressing member 84b (see FIGS. 13B and 13C) is fitted. The comb-shaped upper part pressing member 84a has comb tooth sites cut in a U-shape. The comb tooth sites are configured so as to have the same disposition pitch as the disposition pitch of the punched holes 3a in the bundle of paper-sheets 3″.

The comb-shaped portion is formed with a mixture of a long tooth site 807 and a short tooth site 808. The long tooth site 807 is arranged to project forward more than the edge portion of the bundle of paper-sheets 3″, while the short tooth portion 808 is arranged to project short of the edge portion of the bundle of paper-sheets 3″. This is done so in order to fit the long tooth site 807 into a site selectively opened in the shutter 83, thereby improving an accuracy at which the upper part pressing member 84a and the lower part pressing member 84b are held and fixed and the function of closing the shutter.

The clamper 82b is formed similarly to the right end side and thus its description will be omitted. The clampers 82b and 82a are movably engaged with each other at their rear edges by the above-mentioned fulcrum shaft member 805 and at the front edges thereof, the upper shaft 803 and the lower shaft 804 are movably engaged with the clamp chassis 801 and 802 having the regulation hole (see FIG. 12).

Further, the clampers 82a and 82b have such a structure as to move along the bundle-of-paper-sheets-carrying path I toward the downstream side with respect to the body board 81 in a condition where the bundle of paper-sheets 3″ is held by them. For example, predetermined sites in the clamp movement mechanism 80 are movably engaged in the two sliding grooves 921 and 922 in the right edge frame 92a and the two sliding grooves 923 and 924 in the left edge frame 92b shown in FIG. 8, so that the clamp movement mechanism 80 may be moved toward the downstream side along these four sliding grooves 921 to 924. It is thus possible to move the clamp movement mechanism 80 toward the downstream side independently of the body board 900 and the right and left edge frames 92a and 92b etc. Thus, the clamp movement mechanism 80 may be configured.

The motor 86 in the clamp opening-and-closing drive unit 880 is mounted in the motor mounting region allocated in the left edge frame 92b shown in FIG. 8. It is configured that the motor 86 is engaged with the gear unit 88 which converts the motor rotation number at a predetermined gear ratio and transmits the motor torque to the cams 87a and 87b. The gear unit 88 is fitted with one of the cams, the cam 87b. The cam 87b is fitted to the other cam 87a via a cam interlocking member 809 (see FIG. 12).

The upper arm 801b of each of the clampers 82a and 82b has a roller 826 which constitutes a site acting as a cam. The roller 826 is engaged with the cam 87a or 87b, to release the upper arm 801b. For example, at the time of aligning the bundle of paper-sheets, the motor 86 is driven by the clamp opening-and-closing drive unit 880 and the cams 87a and 87b are driven via the gear unit 88. The cam 87a may release the right edge clamper 82a by pressing the roller 826 of the right edge side upper arm 801b, while the cam 87b may release the left edge clamper 82b by pressing the roller 826 of the left edge side upper arm 801b. Thus, the clampers 82a and 82b may be opened and closed synchronously with each other.

It is to be noted that at the time of aligning the bundle of paper-sheets, the clamp opening-and-closing drive unit 880 fixes the bundle of paper-sheets 3″ by closing the upper arm 801b with respect to the lower arm 801a in a condition where the alignment pins 85a and 85b have been inserted into the punched holes 3a in the bundle of paper-sheets 3″ by the alignment-pin-driving mechanism 91. It is thus possible to align the bundle of paper-sheets 3″ securely at the time of aligning the bundle of paper-sheets.

Further, the shutter 83 is movably fitted on a front surface of the body board 81 and operates to limit discharging of the bundle of paper-sheets 3″ accumulated in the paper-sheet-holding unit 32. It is configured that the shutter 83 is driven up and down in a direction perpendicular to a direction in which the bundle of paper-sheets 3″ are carried. Slide guide members 811 and 812 are provided on right and left sides of the shutter 83 so that the shutter 83 can be slid along the slide guide members 811 and 812. In this embodiment, by closing the shutter 83 when the bundle of paper-sheets 3″ is released free by the clampers 82a and 82b, the bundle of paper-sheets 3″ can be prevented from falling naturally (see FIG. 12).

The shutter 83 is mounted to, for example, a drive shaft 816. With the drive shaft 816, a DC motor (not shown) is fitted and opens and closes the shutter 83 by reciprocating. Of course, the present invention is not limited to this aspect; the rotary movements of the motor (not shown) may be converted into reciprocating movements to open and close the shutter 83.

Further, inside the front surface site of the body board 81, the alignment-pin-driving mechanism 91 described in Embodiment 1 is mounted, to drive the alignment pins 85a and 85b up and down. In this embodiment, it is configured that before the binding process, the alignment pins 85a and 85b are inserted into the punched holes 3a in the bundle of paper-sheets 3″ to realign these positions thereof. A tip of each of the alignment pins 85a and 85b has a cone shape. For example, between the upper part pressing member 84a and the lower part pressing member 84b, the bundle of paper-sheets 3″ are sandwiched and held before the alignment pins are inserted as shown in FIG. 13B.

In this embodiment, in order to align the positions of the holes in the bundle of paper-sheets 3″ by using the alignment pins 85a and 85b, the clampers 82a and 82b are released in a condition where the shutter 83 is closed. Further, as shown in FIG. 13C, the alignment pin 85a is inserted into the punched hole 3a in the bundle of paper-sheets 3″. In this case, the side jogger 70 indicated by a dash-and-two-dots line is configured so that it may be operative to facilitate the insertion of the alignment pins 85a and 85b by swinging the both edges of the bundle of paper-sheets 3″ and also align the positions of the holes in the bundle of paper-sheets 3″. This is done so in order to facilitate the insertion of the binding component 43. The body board 81 fitted with these members is mounted to the paper alignment unit body portion.

Subsequently, a description will be given of operation examples (part one through four) in the clamp movement mechanism 80 with reference to FIGS. 14 to 17. In the example, an assumption is a case where each time the paper-sheet 3′ comes in the paper-sheet-holding unit 32 and butts against the shutter 83 in a condition where the shutter 83 shown in FIG. 12 is closed, the upper arm 801b is closed. The alignment pin 85a stays in a waiting state where it is not inserted into the bundle of paper-sheets 3″.

According to the operation example (part one) when aligning a bundle of paper-sheets in the clamp movement mechanism 80 shown in FIG. 14, the clampers 82b and 82a perform clamping operation at the front ends thereof with reference to the fulcrum shaft member 805 at their rear ends thereof under a state where the upper shaft 803 and the lower shaft 804 are limited by the openings 806a and 806b in the clamp chassis 801 and 802 having the regulation holes.

In this example, the comb-shaped upper part pressing member 84a attached to the upper shaft 803 and the comb-shaped lower part pressing member 84b attached to the lower shaft 804 shown in FIG. 14 hold the paper-sheets 3′ coming into the paper-sheet-holding unit 32. In this moment, it is configured that the long tooth sites 807 shown in FIG. 13A sandwich the bundle of paper-sheets 3″ at a position to which they project forward than the paper edge portion, while the short tooth sites 808 shown in FIG. 13A sandwich the bundle of paper-sheets 3″ at a position to which they project short of the paper edge portion. Further, the long tooth sites 807 are disposed to the opening site in the shutter 83, thereby enabling improving the accuracy of holding and fixing by the upper part pressing member 84a and the lower part pressing member 84b and the accuracy of closing by the shutter 83.

In this moment, the cams 87a and 87b take on a predetermined posture at a cam retreating position Pc (non-home position). For example, it is a condition where protrusions of the cams 87a and 87b face right beside. This condition is a condition where the clampers 82a and 82b are closed by the urging force of a spring (not shown). In this example, it is configured that a home position sensor 821 (hereinafter referred to as an HP sensor 821) for clamping is disposed near the cam 87b and detects a home position (HP) of the clamper 82b etc. to output a home position detection signal (hereinafter referred to as a cam HP detection signal S21) to the control unit 50 (see FIG. 19). The home position HP of the clamper 82b is set to a position (clamper releasing position) to which the upper arm 801b has moved upward most. The clamper 82a is also set similarly and its description will be omitted.

Further, a paper-sheets thickness detection sensor 822 is disposed on the body board 81; and a slit portion 823 is formed in the upper arm 801b and may be used in conjunction with this paper-sheets thickness detection sensor 822. As the paper-sheets thickness detection sensor 822, a transmission type photo-sensor is used. For example, the slit portion 823 includes slit shapes having a predetermined pitch therebetween, so that each time the bundle of paper-sheets 3″ reaches a constant thickness, the edge of the upper arm 801b is detected by the paper-sheets thickness detection sensor 822, and the upper arm 801b performs opening and closing operations, thereby detecting the thickness of the paper-sheets. It is thus configured that the paper-sheets thickness detection sensor 822 detects the thickness of the paper-sheets 3″ coming into the binder paper alignment unit 30 and stacked (bundled) there and output a paper thickness detection signal (not shown) to the control unit 50.

It is to be noted that a 50-paper-sheets thickness detection sensor (hereinafter referred to as a 50-sheets sensor 824) is disposed on the body board 81 adjacent to the paper-sheets thickness detection sensor 822 and a light blocking unit 825 is mounted on the upper arm 801b and used in conjunction with this 50-sheets sensor 824. It is configured that the 50-sheets detection sensor 824 detects a thickness of the paper-sheets 3″ when they are stacked as many as 50 sheets and output a 50-sheets detection signal (not shown) to the control unit 50.

According to the operation example (part two) when aligning a bundle of paper-sheets in the clamp movement mechanism 80 shown in FIG. 15, when the paper-sheet 3′ comes in and when the positions of the punched holes 3a in the bundle of paper-sheets 3″ are to be aligned, the clampers 82a and 82b may be released in a condition where the shutter 83 shown in FIG. 12 is closed, and then the alignment pins 85a and 85b are inserted by the alignment-pin-driving mechanism 91 shown in FIG. 8.

In the clamp movement mechanism 80, the cams 87a and 87b take on predetermined postures at a clamp releasing position (home position HP) thereof. For example, in a condition where the clampers 82a and 82b shown in FIG. 14 are closed, the motor 86 transmits the motor torque to the cams 87a and 87b via the gear unit 88 in which rotation number thereof is converted at a predetermined gear ratio. As a result thereof, a condition occurs where the cams 87a and 87b rotate by 90 degrees clockwise from the cam retreating position Pc. In this moment, at the clampers 82a and 82b respectively, the protrusion of the cam 87a is pressed by the roller 826 of the lower arm 801a and the protrusion of the cam 87b is pressed by the roller 826 of the lower arm 801b, thereby releasing the clampers 82a and 82b synchronously with each other.

In the clamper chassis 801 and 802 having the regulation holes, the lower arm 801a and the upper arm 801b operate to open by using the fulcrum shaft member 805 as a movable reference. In this moment, the lower shaft 804 and the upper shaft 803 are limited in movement by the elongated openings 806a and 806b in the clamp chassis 801 and 802, so that a width to which the clamps are released may be limited in the clamper chassis 801 and 802. The driving force is transmitted to the lower shaft 804 attached to the lower arm 801a movably and the upper shaft 803 attached to the upper arm 801b movably.

As a result thereof, the bundle of paper-sheets 3″ is released free by the comb-shaped upper part pressing member 84a attached to the upper shaft 803 and the comb-shaped lower part pressing member 84b attached to the lower shaft 804. Even if these clampers 82a and 82b makes the bundle of paper-sheets 3″ free released, the bundle of paper-sheets 3″ may be prevented from falling naturally because the shutter 83 is closed. Then, it is configured that the motor 89 is driven and the normal-directional rotation movement of the motor 89 is converted into a pin raising movement by the alignment-pin-driving mechanism 91 shown in FIG. 8, thus permitting the alignment pins 85a and 85b to pass through the punched holes 3a in the bundle of paper-sheets 3″. In this moment, it is configured that the side jogger 70 shown in FIG. 5 facilitates the insertion of the alignment pins 85a and 85b by swinging the both sides of the bundle of paper-sheets 3″. It is thus possible to align the positions of the holes 3a in the bundle of paper-sheets 3″.

According to the operation example (part three) when aligning a bundle of paper-sheets in the clamp movement mechanism 80 shown in FIG. 16, the clamps are locked again in a condition where the alignment pins are inserted into the aligned punched holes 3a in the bundle of paper-sheets 3″. In this example, a case where the alignment pins 85a and 85b are pulled out of the bundle of paper-sheets 3″ as shown in FIG. 11 will be described.

According to the clamp movement mechanism 80 shown in FIG. 16, the cams 87a and 87b stay in a condition where they have returned from the clamp releasing position (home position HP) to the cam retreating position Pc and their protrusions face right beside. In this condition, the motor 86 rotates reversely and transmits the motor torque to the cams 87a and 87b via the gear unit 88 in which rotation number is converted to a predetermined gear ratio. Then, it is based on a result such that the cams 87a and 87b have rotated by 90 degrees counterclockwise from the clamp releasing position (home position HP) to return to the cam retreating position Pc thereof.

Through the cam retreating operations, the clampers 82a and 82b take on predetermined postures at arbitrary positions in accordance with the thickness of the bundle of paper-sheets 3″ owing to the urging force of the spring (not shown). For example, at the clampers 82a and 82b respectively, the protrusion of the cam 87a is not pressed by the roller 826 of the lower arm 801a and the protrusion of the cam 87b is not pressed by the roller 826 of the upper arm 801b, thereby closing the clampers 82a and 82b synchronously with each other.

In the clamper chassis 801 and 802, the lower arm 801a and the upper arm 801b operate so as to be closed by using the fulcrum shaft member 805 as a movable reference. The driving force is transmitted to the lower shaft 804 attached to the lower arm 801a movably and the upper shaft 803 attached to the upper arm 801b movably. As a result thereof, the bundle of paper-sheets 3″ may be held and fixed by the comb-shaped upper part pressing member 84a attached to the upper shaft 803 and the comb-shaped lower part pressing member 84b attached to the lower shaft 804.

Then, it is configured that the motor 89 is driven and its reverse-directional rotation movement is converted into a lowering movement by the alignment-pin-driving mechanism 91 shown in FIG. 8, thus pulling the alignment pins 85a out of the punched holes 3a in the bundle of paper-sheets 3″. It is thus possible to hold and fix the bundle of paper-sheets 3″ in a condition where the positions of the punched holes 3a therein are aligned. During these operations, the shutter 83 operates to limit the discharging of the bundle of paper-sheets 3″ accumulated in the paper-sheet-holding unit 32.

According to the operation example (part four) when aligning a bundle of paper-sheets in the clamp movement mechanism 80 shown in FIG. 17, an example is referenced in which the clamped bundle of paper-sheets 3″ is moved toward the downstream side. It is configured that in FIG. 17, the clamp movement mechanism 80 is independent of the body board 900, the right and left edge frames 92a and 92b, etc. shown in FIG. 8 and is moved toward the downstream side along the predetermined slide grooves 921 to 924. Immediately prior to this movement, the shutter 83 shown in the same figure is opened so as to be slid in a direction perpendicular to the direction in which the bundle of paper-sheets 3″ are carried. It is thus possible to send to a next step the bundle of paper-sheets 3″ that is accumulated in the paper-sheet-holding unit 32 and has the punched holes 3a thereof realigned.

Subsequently, a description will be given of an example of a control example of oscillation in the binder paper alignment unit 30 with reference to FIGS. 18A to 18G. In this example, the alignment pin drive mechanism and/or the clamp movement mechanism 80 are equipped with an oscillation unit, which oscillates the alignment pins 85a and 85b and/or the upper arm 801b when aligning the bundle of paper-sheets. Also as the oscillation unit, the motor 86 or 89 is used. It is thus possible to reduce the frictional resistance between the paper-sheets 3′ when aligning the bundle of paper-sheets. For example, even if the frictional resistance increases in a condition where the paper-sheets 3′ are once pressed by a retry operation, it is possible to reduce the frictional resistance again by oscillating the alignment pins 85a and 85b and/or the upper arm 801b.

In all of FIGS. 18A to 18F, the horizontal axis represents a time “t”. FIG. 18A represents a period of time [ms] elapsed since a point of time when a pin operation start instruction is given. For example, it relates to time data DATA related to the period of elapsed time output from a timer that is activated when the pin operation start instruction is issued by the control unit 50. In the embodiment, time-out is encountered in 200 [ms] since the issuance of the pin operation start instruction. Oscillation lasts for only N=1000 [ms] from the time data DATA=200 [ms] to 1200 [ms]. FIG. 18B is a time chart indicating an operation example of the alignment pins 85a and 85b. The alignment pins 85a and 85b have three states of “projected”, “stopped”, and “retreated”.

In the embodiment, the alignment pins 85a and 85b stay in the projected state during a lapse of time from the issuance of the pin operation start instruction to DATA=200 [ms], from DATA=250 [ms] to 350 [ms], from DATA=550 [ms] to 650 [ms], from DATA=850 [ms] to 950 [ms], and DATA=1150 [ms] and onward. Further, the alignment pins 85a and 85b stay in the retreated state from DATA=400 [ms] to 500 [ms], from DATA=700 [ms] to 800 [ms], and from DATA=1000 [ms] to 1100 [ms].

The alignment pins 85a and 85b stay in the stopped state at the other lapses of time from DATA=200 [ms] to 250 [ms], from DATA=350 [ms] to 400 [ms], from DATA=500 [ms] to 550 [ms], from DATA=650 [ms] to 700 [ms], from DATA=800 [ms] to 850 [ms], from DATA=950 [ms] to 1000 [ms], and from DATA=1100 [ms] to 1150 [ms].

FIG. 18C is a time chart indicating an operation example of the upper end detection sensor 94 for the alignment pins 85a and 85b. The upper end detection sensor 94 stays in the “OFF” state when it is at the lower level (hereinafter referred to as an “L” level), which is a state in which the upper end of any of the alignment pins is not detected. It stays in the “ON” state when it is at the high level (hereinafter referred to as an “H” level), which is a state in which the upper end of any of the alignment pins is detected. In the embodiment, before and after the pin operation start instruction is issued, the upper end detection sensor 94 stays in the “OFF” state when it is at the “L” level.

FIG. 18D is a time chart indicating an operation example of the HP detection sensor 93 for the alignment pins 85a and 85b. The HP detection sensor 93 stays in the “ON” state when it is at the “H” level, which is a state in which the home position HP of any of the alignment pins 85a and 85b is detected. It stays in the “OFF” state when it is at the “L” level, which is a state in which the home position HP of any of the alignment pins 85a and 85b is not detected. In the embodiment, until the pin operation start instruction is issued, the HP detection sensor 93 stays in the “ON” state when it is at the “H” level. Since the time when the pin operation start instruction is issued, the upper end detection sensor 94 stays in the “OFF” state when it is at the “L” level.

FIG. 18E is a time chart indicating an operation example of the upper arm 801b of the clamper 82a or 82b. The upper arm 801b has three states of “retreated position”, “aligned position”, and “pressed position”. In the embodiment, until the pin operation start instruction is issued, the upper arm 801b stays in the “pressed position” state. During a lapse of time from the issuance of the pin operation start instruction to DATA=100 [ms], it shifts from the “pressed position” to the “retreated position”. From DATA=100 [ms] to 200 [ms], it keeps the “retreated position” state. At DATA=200 [ms], the upper arm 801b shifts from the “retreated position” to the “aligned position” and, from the DATA=250 [ms] onward, starts to oscillate.

FIG. 18F is a time chart indicating an operation example when the side jogger 70 is in a width-truing-up mode #1. The side jogger 70 has three states of “retreated position”, “oscillated position”, and “reference position”. In the width-truing-up mode #1, until the pin operation start instruction is issued, the side jogger 70 stays in the “reference position” state. If the pin operation start instruction is issued, the width-truing-up guide 72a and the width-truing-up reference guide 72b shift from the “reference position” to the “retreated position”. From DATA=50 [ms] to 200 [ms], they keep the “retreated position” state thereof. At DATA=200 [ms], the width-truing-up guide 72a and the width-truing-up reference guide 72b shift from the “retreated position” to the “oscillated position” and, from the DATA=250 [ms] onward, start to oscillate.

FIG. 18G is a time chart indicating an operation example when the side jogger 70 is in a width-truing-up mode #2. In the width-truing-up mode #2, before and after the pin operation start instruction is issued, the side jogger 70 stays in the “retreated position” state. In the embodiment, from the issuance of the pin operation start instruction up to DATA=200 [ms], it stays in the “retreated position” state. At point of time of DATA=200 [ms], the width-truing-up guide 72a and the width-truing-up reference guide 72b shift from the “retreated position” to the “oscillated position”. At point of time of DATA=250 [ms], the width-truing-up guide 72a and the width-truing-up reference guide 72b oscillate.

Subsequently, a description will be given of a configuration example of a control system of the binder paper alignment unit with reference to FIG. 19. The motor drive units 35 and 36, the HP detection sensor 93 for the alignment pins, the upper end detection sensor 94, an HP sensor 115 for the press roller, an HP sensor 117 for the curl fence, the paper-sheet detection sensor 119, a discharge roller drive unit 122, motor drive units 180 to 185, and the HP sensor 821 for clamping are connected to the control unit 50 shown in FIG. 19.

The paper-sheet detection sensor 119 detects the paper-sheet 3′ discharged from the punch processing unit 20 and outputs a paper-sheet detection signal S19 to the control unit 50. Based on the paper-sheet detection signal S19, the control unit 50 controls the motor drive units 35 and 36 and the motor drive units 180 to 185. For example, it outputs a motor control signal S36 to the motor drive unit 36 based on the paper-sheet detection signal S19. A discharge roller rotating motor 205 is connected to the discharge roller drive unit 122. The discharge roller drive unit 122 receives a motor control signal S22 from the control unit 50 to drive the motor 205 so that the discharge roller 25 may rotate. The paper-sheet 3′ discharged from the punch processing unit 20 is carried by the rotation of the discharge roller 25 to thereby come into the binder paper alignment unit 30.

The HP sensor 117 detects a position of any protrusions 342 on the curl fence unit 34b etc. and outputs a home position (hereinafter referred to as an HP) detection signal S17 to the control unit 50. The control unit 50 outputs a motor control signal S35 to the motor drive unit 35 based on the paper-sheet detection signal S19 and the HP detection signal S17. A curl fence rotating motor 301 is connected to the motor drive unit 35. The motor drive unit 35 receives the motor control signal S35 from the control unit 50 to rotate the motor 301, thereby driving the curl fence units 34a and 34b.

A paddle roller rotating motor 708 is connected to the motor drive unit 36. The motor drive unit 36 receives a motor control signal S36 from the control unit 50 to rotate the motor 708, thereby driving the paddle roller 37. A motor 308 for the clamp movement mechanism is connected to the motor drive unit 180. The motor drive unit 180 receives a motor control signal S80 from the control unit 50 to rotate the motor 308, thereby driving the clamp movement mechanism 80. For example, it is configured that the clamp movement mechanism 80 opens the shutter 83 and lowers the clamp members sandwiching the bundle of paper-sheets 3″ to move it to a next step. Then, it is configured that the mechanism releases the bundle of paper-sheets 3″ and raises the clamp members to close the shutter 83.

The HP sensor 821 for clamping detects the clamp releasing position of the clamp movement mechanism 80. In the embodiment, it detects the home position HP of the cam 87a, 87b with respect to the home position (HP) of the clamper 82a, 82b or the like and outputs the cam HP detection signal S21 to the control unit 50. When aligning the bundle of paper-sheets, the control unit 50 controls the clamp member moving motor 86 via the motor drive unit 181 based on the cam HP detection signal S21.

The clamp member moving motor 86 is connected to the motor drive unit 181. The motor drive unit 181 receives a motor control signal S81 from the control unit 50 to drive the motor 86, thereby driving the clamp members such as the lower arm 801a and the upper arm 801b etc. When aligning the bundle of paper-sheets, the clamp members are released. In the case of sandwiching the bundle of paper-sheets 3″, the clamp members are closed.

The HP detection sensor 93 detects the home position HP of the alignment pins 85a and 85b and outputs a pin HP detection signal S93 to the control unit 50. The home position HP of the alignment pins 85a and 85b is referred to as a position dropped from the paper-sheet alignment surface by a predetermined distance. The alignment pins 85a and 85b are arranged to wait at this position. The upper end detection sensor 94 detects an upper end of the alignment pins 85a and 85b and outputs a pin top detection signal S94 to the control unit 50. When aligning the bundle of paper-sheets, the control unit 50 controls the pin member moving motor 89 via the motor drive unit 182 based on the pin HP detection signal S93 and the pin top detection signal S94.

The alignment pin driving motor 89 is connected to the motor drive unit 182. The motor drive unit 182 receives a motor control signal S82 from the control unit 50 to rotate the motor 89, thereby driving the decelerating gear 98, the UD rack 95, the link 96, the X-shaped arms 99a and 99b, the alignment pins 85a and 85b, etc. When aligning the bundle of paper-sheets, the alignment pins 85a and 85b are inserted into the punched holes 3a in the bundle of paper-sheets 3″. The motors 74a and 74b for the side jogger are connected to the motor drive unit 183. The motor drive unit 183 receives the motor control signal S83 from the control unit 50 to rotate the motors 74a and 74b, thereby driving the side jogger 70. It is configured that when aligning the bundle of paper-sheets, the width-truing-up guide 72a and the width-truing-up reference guide 72b of the side jogger 70 true up the width direction of the bundle of paper-sheets 3″. When discharging the bundle of paper-sheets, the width-truing-up guide 72a and the width-truing-up reference guide 72b are retreated.

The HP sensor 115 detects the position of the press rollers 33 and outputs a roller detection signal S15 to the control unit 50. Home position of the press rollers is referred to as a position raised from the paper-sheet alignment surface by a predetermined distance. The press rollers 33 are arranged to wait at this position. When discharging the bundle of paper-sheets, the control unit 50 controls the press rollers 33 and the supply roller (not shown) based on the roller detection signal S15.

A press roller moving motor 814 is connected to the motor drive unit 184. The motor drive unit 184 receives a motor control signal S84 from the control unit 50 to rotate the motor 89, thereby driving the press rollers 33. A supply roller rotating motor 815 is connected to the motor drive unit 185. The motor drive unit 185 receives the motor control signal S85 from the control unit 50 to rotate the motor 815, thereby driving the supply roller. It is configured that when discharging the bundle of paper-sheets, the above-mentioned press rollers 33 and supply roller send the bundle of paper-sheets 3″ to a next step with a pressure being applied to it from its right surface and back surface sides.

Subsequently, a description will be given of a control example when aligning the paper-sheets in the binding device 100 with reference to FIG. 20. In the embodiment, the width-truing-up reference guide 72b of the side jogger 70 retreats in synchronization with the clamp movement mechanism 80 in such a direction as to exceed a width of the paper-sheet so that the bundle of paper-sheets 3″ may not be sandwiched when the alignment pins 85a and 85b are inserted after the bundle of paper-sheets is aligned. In the embodiment, as shown in FIGS. 18E and 18F, the frictional resistance between the paper-sheets 3′ can be reduced by oscillating the clamp movement mechanism 80 and the pins 85a and 85b when inserting the pins.

Under such control conditions, at step ST1 of a flowchart shown in FIG. 20, it awaits for the pin operation start instruction. If the start instruction is issued from the higher-order control system, at step ST2, the paddle roller 37 is retreated. Next, at step ST3, the width-truing-up guide 72a and the width-truing-up reference guide 72b in the side jogger 70 are retreated. In the embodiment, the width-truing-up mode #1 described in FIG. 18E is carried out.

At step ST4, the upper arms 801b of the clamp chassis 801 and 802 are released to a predetermined position. In the embodiment, the upper arms 801b are released to the intermediate position to facilitate the alignment of the bundle of paper-sheets 3″. The alignment pins 85a and 85b are already retreated to the outside of the bundle-of-paper-sheets carrying path I.

At step ST5, the alignment pins 85a and 85b are projected from the lower arm side to the upper arm side to perform the pin alignment. In this moment, simultaneously with the projection of the alignment pins 85a and 85b, the upper arm 801b starts releasing operations. The alignment pins 85a and 85b are inserted as the upper arm 801b relaxes its force pressing down the paper-sheets 3′. The upper arms 801b are released up to an arbitrary intermediate position which is larger than a thickness of the booklet and smaller than the height of the bundle-of-paper-sheets-carrying path I and are stopped there and they wait at this position until the upper end detection sensor 94 detects that the alignment pins 85a and 85b have reached the upper edge position. It is thus possible to perform pin alignment by inserting the alignment pins 85a and 85b into the punched holes 3a in a condition where the upper arms 801b are open.

At step ST6, the control unit 50 determines whether the alignment pins 85a and 85b have passed through the punched holes 3a. In the embodiment, the upper end detection sensor 94 monitors a lapse of time from the start of the projection of the alignment pins 85a and 85b until their arrival at the upper end. If the alignment pins 85a and 85b fail to reach the upper end within a predetermined lapse of time, a shift is made to pin alignment retry operations. The upper end detection signal S94 is output to from the upper end detection sensor 94 to the control unit 50. The control unit 50 determines whether the upper end detection sensor 94 has detected the alignment pins' upper end based on the upper end detection signal S94. If the upper end detection sensor 94 does not detect the alignment pins' upper end, a shift is made to step ST7 to oscillate the alignment pins 85a and 85b (retry operations). The alignment-pin-driving mechanism 91 performs the retry operations by repeating the normal rotation and reverse rotation of the motor 89 in a predetermined lapse of time a plurality of number of times. It is thus possible to give oscillations to the alignment pins 85a and 85b, thereby reducing the frictional resistance between the paper-sheets.

Then, a shift is made to step ST8 to oscillate the upper arms 801b of the clampers 82a and 82b. In this moment, the retry operations are carried out by repeating a plurality of number of times the normal rotation and reverse rotation, by a predetermined number of pulses, of the motor 86 acting as driving means of the upper arms 801b stopped at the arbitrary position depending on the thickness of the bundle of paper-sheets 3″. It is thus possible to give oscillations to the upper arms 801b, thereby reducing the frictional resistance between the paper-sheets.

Then, a shift is made to step ST9 to oscillate the width-truing-up guide 72a and the width-truing-up reference guide 72b in the side jogger 70. In the embodiment, the width-truing-up mode #2 described in FIG. 18F is carried out. Then, at step ST10, the control unit 50 determines whether the upper end detection sensor 94 has detected the alignment pins' upper end in order to determine whether the pins are inserted. If the upper end detection sensor 94 has detected the alignment pins' upper end, a shift is made to step ST11. Further, if the upper end detection sensor 94 has already detected the alignment pins' upper end at the aforesaid step ST6, the aforesaid steps ST7 to ST10 are skipped to shift to step ST11.

After the pins are inserted, at step ST11 the upper arms 801b of the clampers 82a and 82b are closed. At this point in time, the alignment pins 85a and 85b have reached the upper end thereof. By closing the clampers 82a and 82b in a condition where the alignment pins 85a and 85b are inserted, the bundle of paper-sheets 3″ can be aligned securely. After the upper arms 801b have moved in the closing direction to complete the closing, a shift is made to step ST12 to retreat the alignment pins 85a and 85b. In the embodiment, the alignment pins 85a and 85b retreat to the lower end position thereof. This completes the pin alignment to complete the alignment of the bundle of paper-sheets 3″ at step ST13. It is to be noted that if the alignment pins' upper end cannot be detected by the upper end detection sensor 94 even after the predetermined lapse of time elapses, a shift is made to step ST14 to perform error handling. For example, an error display processing may be performed on a display unit (not shown) to indicate causes of the error.

In such a manner, according to the binding device 100 according to Embodiment 2, when aligning the positions of the punched holes 3a perforated at predetermined positions and bundling a plurality of the paper-sheets 3′ into the bundle of paper-sheets 3″, in the alignment-pin-driving mechanism 91 mounted on the side of the lower arm, the motor 89 rotates to drive the decelerating gear 98, the UD rack 95, the link 96, the X-shaped arms 99a and 99b, etc., thereby reciprocating the alignment pins 85a and 85b between the fixing lower arm 801a and the movable upper arm 801b released at the intermediate position. Therefore, the punched holes 3a in the bundle of paper-sheets 3″ can be inserted from the lower arm side to the upper arm side. Moreover, the pins can be inserted with less frictional resistance between the paper-sheets without pressing down the bundle of paper-sheets 3″. It is thus possible to reduce irregularities in the state of the paper-sheets 3′ of the bundle of paper-sheets 3″.

Further, even if the frictional resistance is increased because the paper-sheets 3′ are pressed down once, the retry operations can be carried out to reduce the frictional resistance again. Therefore, it is possible to carry the bundle of paper-sheets 3″ to a next step with the punched holes 3a after the paper-sheets alignment being aligned in a condition where the bundle of paper-sheets 3″ is fixed with the lower arm 801a and the upper arm 801b.

Although in the above-mentioned embodiments, a case has been described where the paper-sheets 3′ are realigned at a point of time when a predetermined number of the paper-sheets 3′ are stacked in the paper-sheet-holding unit 32, the present invention is not limited to it; the pins may be aligned each time the paper-sheet 3′ comes into the paper-sheet-holding unit 32 or a plurality of number of the paper-sheets 3′ are encountered, thus reducing the frictional resistance between the paper-sheets 3′. Further, each time one or a plurality of number of the paper-sheets come in, the alignment pins 85a and 85b may be projected little by little to align the paper-sheets as inserting the pins into the punched holes 3a. Furthermore, the punched holes 3a may be realigned as performing fine positional control by using a stepping motor as the driving means of the alignment pins 85a and 85b.

### INDUSTRIAL APPLICABILITY

The present invention is very preferably applicable to a binding device that performs binding process on recording paper-sheets released from a copy machine and a print machine for black-and-white and color use.

1. A paper-sheet handling device that aligns positions of hole portions perforated at predetermined positions, respectively, and that binds a plurality of paper-sheets into a bundle of paper-sheets, characterized in that the device is provided with:
a paper-sheet-holding unit that causes the plurality of paper-sheets to butt against a reference position and stacks these paper-sheets to hold them temporarily; and
bar-shaped bodies for alignment, which align the hole portions in the plurality of paper-sheets temporarily held by the paper-sheet-holding unit,
wherein supposing that a distance from the reference position up to a predetermined position of the bar-shaped bodies is S1 and a distance from front edges of the paper-sheets up to a predetermined position of the hole portions is S2, the bar-shaped bodies are disposed with respect to the reference position in such a manner as to satisfy a relationship of S1>S2.

2. The paper-sheet handling device according to claim 1, characterized in that:
the predetermined position of the bar-shaped bodies is a position of a shaft center of any of the bar-shaped bodies; and
the predetermined position of the hole portions is a position of a center of any of the hole portions.

3. The paper-sheet handling device according to claim 1, characterized in that the device is provided with:
a bundle-of-paper-sheets-carrying path along which the bundle of paper-sheets is carried; and
a bundle-of-paper-sheets carriage opening-and-closing mechanism that opens and closes the bundle-of-paper-sheets-carrying path,
wherein the bundle-of-paper-sheets carriage opening-and-closing mechanism has a reference position which is formed when the bundle-of-paper-sheets-carrying path is closed.

4. The paper-sheet handling device according to claim 1, characterized in that the device is provided with a guide member for truing up widths, which aligns side ends of the paper-sheets temporarily held by the paper-sheets-holding unit,
wherein when the bar-shaped bodies for the alignment are inserted through the hole portions in the paper-sheets or before the bar-shaped bodies are inserted through the hole portions in the paper-sheets, the guide member is retreated from the bundle-of-paper-sheets-carrying path.

5. The paper-sheet handling device according to claim 1, characterized in that the device is provided with:
a paper-sheet fixing and carrying mechanism that has a fixing clamp member and a movable clamp member and carries the bundle of paper-sheets with the bundle of the paper-sheets being fixed; and
a bar-shaped-bodies-driving mechanism that reciprocates said bar-shaped bodies between the fixing clamp member and the movable clamp member of the paper-sheet fixing and carrying mechanism,
wherein, at the time of aligning the bundle of the paper-sheets, the bar-shaped bodies are projected from a side of the fixing clamp member to a side of the movable clamp member.

6. The paper-sheet handling device according to claim 5, characterized in that
the bar-shaped-bodies-driving mechanism and/or the paper-sheet fixing and carrying mechanism are equipped with an oscillation unit; and
at the time of aligning the bundle of paper-sheets, the oscillation unit oscillates the bar-shaped bodies and/or the movable clamp member.

7. The paper-sheet handling device according to claim 5, characterized in that
the paper-sheet fixing and carrying mechanism is provided with a clamp opening-and-closing drive unit that drives the movable clamp member; and
at the time of aligning the hole portions in the paper-sheets, the clamp opening-and-closing drive unit moves the movable clamp member to a predetermined position with respect to the fixing clamp member, thereby releasing the bundle of paper-sheets.

8. The paper-sheet handling device according to claim 7, characterized in that at the time of aligning the bundle of paper-sheets, the clamp opening-and-closing drive unit starts moving the movable clamp member with respect to the fixing clamp member simultaneously with starting of insertion of the bar-shaped bodies into the hole portions in the paper-sheets by the bar-shaped-bodies-driving mechanism.

9. The paper-sheet handling device according to claim 7, characterized in that, at the time of aligning the bundle of paper-sheets, the clamp opening-and-closing drive unit fixes the bundle of paper-sheets by closing the movable clamp member with respect to the fixing clamp member in a condition where the bar-shaped bodies are inserted into the hole portions in the paper-sheets by the bar-shaped-bodies-driving mechanism.
